(19) United States
(12) Patent Application Publication
(10) Pub. No.: US 2026/0231030 A1
(43) Pub. Date: Aug. 6, 2026

(54) METHODS AND ARRANGEMENTS FOR LOW-POWER WAKE-UP SIGNALING

(71) Applicant: Intel Corporation, Santa Clara, CA (US)

(72) Inventors: YINGYANG LI, Beijing (CN); YI WANG, Beijing (CN); GANG XIONG, Portland, OR (US); YUJIAN ZHANG, Beijing (CN)

(73) Assignee: Intel Corporation, Santa Clara, CA (US)

(21) Appl. No.: 19/148,588

(22) PCT Filed: Feb. 15, 2024
(86) PCT No.: PCT/US2024/015960

§ 371 Date: Jul. 16, 2025

Related U.S. Application Data
(60) Provisional application No. 63/485,487, filed on Feb. 16, 2023.

(51) Int. Cl. H04W 52/02; H04B 17/318

(52) U.S. Cl. CPC H04W 52/0235; H04B 17/328

(57) ABSTRACT

Logic may generate or decode a low-power wake-up signal (LP-WUS) received via the interface, the LP-WUS comprising wake-up signal (WUS) symbols, the WUS symbols modulated with an on-off keying (OOK) modulation or a frequency shift keying (FSK) modulation, the LP-WUS comprising information to perform at least one low-power wake-up radio (LP-WUR) function via a LP-WUR of the UE while a main radio of the UE is powered off, wherein the LP-WUR function comprises measurement of at least part of the LP-WUS. And logic may determine at least one metric based on the measurement or cause transmission of the LP-WUS.

### CROSS REFERENCE TO RELATED APPLICATIONS

This application also claims priority under 35 USC § 119 from U.S. Provisional Application No. 63/485,487, entitled “MEASUREMENT BY LOW-POWER WAKE-UP SIGNALING”, filed on Feb. 16, 2023, the subject matter of which is incorporated herein by reference.

### BACKGROUND

Fifth generation (5G) cellular systems are designed and developed targeting for both mobile telephony and vertical use cases. Besides latency, reliability, and availability, user equipment (UE) energy efficiency is also critical to 5G. Currently, battery powered 5G devices such as UEs may have to be recharged per week or day, depending on individual's usage time. In general, 5G devices consume tens of milliwatts in radio resource control (RRC) idle/inactive state and hundreds of milliwatts in RRC connected state. Designs to prolong battery life is a necessity for improving energy efficiency as well as for better user experience.

The power consumption depends on the configured length of wake-up periods, e.g., paging cycle. To meet the battery life requirements above, a long discontinuous reception (DRX) cycle is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, a long DRX cycle cannot meet the delay requirements. There exists a need to reduce the power consumption with a reasonable latency.

### BRIEF DESCRIPTION OF THE DRAWINGS

FIG. 1 depicts an embodiment of a system including base stations, user equipment, and cloud-based computing and data services interconnected via a communication network;

FIG. 2 illustrates another embodiment of a network in accordance with various embodiments such as the network in FIG. 1;

FIG. 3 illustrates another embodiment of a network in accordance with various embodiments;

FIG. 4A depicts an embodiment of user equipment with a main radio in an off or deep sleep state in accordance with various embodiments;

FIG. 4B depicts an embodiment of user equipment with a main radio in an on or powered state in accordance with various embodiments;

FIG. 4C depicts an embodiment of a subframe comprising a low-power wake-up signal (LP-WUS) in accordance with various embodiments;

FIG. 4D depicts an embodiment of a low-power wake-up signal (LP-WUS) and determination of a metric such as a reference signal received power (RSRP) based on a sequence of on-off keying (OOK) symbols of the LP-WUS;

FIG. 5 depicts an embodiment of a simplified block diagram of a base station and a user equipment (UE) such as the base stations or RANs, the UEs, and communication networks shown in FIGS. 1-4;

FIG. 6 depicts a flowchart of an embodiment for user equipment for cell reselection based on measurements by a low-power wake-up radio and a main radio such as the embodiments described in conjunction with FIGS. 1-5;

FIG. 7 depicts a flowchart of an embodiment for a base station such as the embodiments described in conjunction with FIGS. 1-5;

FIG. 8 depicts an embodiment of protocol entities that may be implemented in wireless communication devices;

FIG. 9 illustrates embodiments of the formats of PHY data units (PDUs) that may be transmitted by the PHY device via one or more antennas and be encoded and decoded by a MAC entity such as the processors in FIG. 5, the baseband circuitry in FIGS. 5, 13, and 14 according to some aspects;

FIGS. 10A-B depicts embodiments of communication circuitry such as the components and modules shown in the user equipment and base station shown in FIG. 5;

FIG. 11 depicts an embodiment of a storage medium described herein;

FIG. 12 illustrates an architecture of a system of a network in accordance with some embodiments;

FIG. 13 illustrates example components of a device in accordance with some embodiments such as the base stations and UEs shown in FIGS. 1-12;

FIG. 14 illustrates example interfaces of baseband circuitry in accordance with some embodiments such as the baseband circuitry shown and/or discussed in conjunction with FIGS. 1-13; and

FIG. 15 depicts an embodiment of a block diagram of components to perform functionality described.

### DETAILED DESCRIPTION OF EMBODIMENTS

The following is a detailed description of embodiments depicted in the drawings. The detailed description covers all modifications, equivalents, and alternatives falling within the appended claims.

Currently, user equipment (UE) periodically wakes up once per discontinuous reception (DRX) cycle, which dominates the power consumption in periods with no signaling or data traffic. If UEs are able to wake up only when they are triggered, e.g., paging, power consumption could be dramatically reduced. This can be achieved by using a wake-up signal to trigger a low power wake-up radio (LP-WUR) to wake the main radio. The LP-WUR may have the ability to monitor the wake-up signal with ultra-low power consumption. The main radio may wake to perform data transmission and reception and enter a deep sleep unless turned on by the LP-WUR.

Embodiments may include a LP-WUR and a main radio and may include low-power wake-up radio (LP-WUR) logic circuitry for performing LP-WUR functionality such as measurements, paging reception, cell selection/reselection, beam failure detection (BFD), radio link monitoring (RLM), synchronization, and/or the like via low-power wake-up signaling. In some embodiments, the LP-WUR logic circuitry may perform the LP-WUR functionality without waking up the main radio. In some embodiments, the LP-WUR logic circuitry may perform the LP-WUR functionality to reduce a required wake up time of the main radio. In some embodiments, the LP-WUR logic circuitry may perform the LP-WUR functionality to reduce a required wake up time of the main radio to perform main radio functions such as measurements, paging reception, cell selection/reselection, beam failure detection (BFD), radio link monitoring (RLM), synchronization, and/or the like. In some embodiments, the LP-WUR logic circuitry may perform the LP-WUR functionality to determine whether or not to awake the main radio.

In some embodiments, the LP-WUR may wake-up, or apply power to, the main radio in response to receipt of a low-power wake-up signal (LP-WUS). In many embodiments, the LP-WUR may perform measurements based on low-power wake-up signaling without waking up the main radio except for situations that are predefined, preconfigured, or configured by, e.g., higher layer signaling such as radio resource control (RRC) signaling.

The LP-WUR may receive low-power wake-up signaling having amplitudes modulated via on-off keying (OOK) modulation or frequency shift keying (FSK) modulation. Furthermore, the LP-WUR may require different metrics for measurements than the main radio, which may be defined and transmitted to the LP-WUR in system information blocks (SIBs).

The LP-WUR logic circuitry of a base station may cause transmission of SIBs, via low-power wake-up signaling, with metrics for measurements by a LP-WUR. The LP-WUR logic circuitry of a UE may receive SIBs with metrics for measurement via a LP-WUR, determine the metrics for measurements based on the SIBs, perform measurements based on the metrics for the LP-WUR, perform cell selection/reselection via low-power wake-up signals (LP-WUSs) and the LP-WUR, and wake up a main radio.

In some embodiments, for cell selection/reselection, the LP-WUR logic circuitry of a UE may wake up the main radio in response to a determination to change to a new cell, and the main radio may redo performance of radio resource management (RRM) measurements based on the metrics for the LP-WUR and/or based on metrics for the main radio prior to registering with a new cell, if applicable. In some embodiments, the LP-WUR logic circuitry may adjust the RRM measurements for cell selection/reselection by the LP-WUR via a scaling factor and/or an offset to adjust the measurements to more closely match or match the RRM measurements by the main radio. In some embodiments, the LP-WUR logic circuitry may adjust the RRM measurements for cell selection/reselection by the LP-WUR via a transformation function of the measurements by the LP-WUR. In some embodiments, the LP-WUR logic circuitry may adjust the RRM measurements used for cell selection/reselection via a function of the RRM measurements by the main radio and the measurements by the LP-WUR. In some embodiments, the LP-WUR logic circuitry may adjust the RRM measurements used for cell selection/reselection via a function of the RRM measurements by the main radio. In some embodiments, the LP-WUR logic circuitry may adjust the measurements via one or more functions to transform the RRM measurements by the LP-WUR and/or by the main radio may include a validation level for the RRM measurements by the LP-WUR and/or by the main radio. In many embodiments, higher layer signaling (e.g., radio resource control (RRC) layer, other protocol layer, or the like) may predefine, preconfigure, or configure the function for transforming the RRM measurements.

In some embodiments, the LP-WUR logic circuitry of a UE may select the best measurements from the measurements by the main radio and the measurements by the LP-WUR for cell selection/reselection or other. In some embodiments, higher layer signaling (e.g., RRC layer, other protocol layer, or the like) may predefine, preconfigure, or configure the selection criteria for selection of the best measurement.

In some embodiments, the LP-WUR logic circuitry of a UE may perform beam failure detection (BFD) via the LP-WUR. In some embodiments, the LP-WUR logic circuitry of a UE may perform radio link monitoring (RLM) via the LP-WUR. In some embodiments, the LP-WUR logic circuitry of a UE may determine paging reception via the LP-WUR. In some embodiments, the LP-WUR logic circuitry of a UE may receive, demodulate, decode, and interpret SIBs via the LP-WUR. In some embodiments, the LP-WUR logic circuitry of a UE may obtain synchronization via the LP-WUR.

Various embodiments may be designed to address different technical problems associated with power consumption by a main radio of a UE; short DRX cycles for a main radio of a UE due to periodic, sporadic, or occasional requirements to perform measurements such as RRM measurement; short DRX cycles for a main radio of a UE due to periodic, sporadic, or occasional requirements to perform cell selection and/or cell reselection; short DRX cycles for a main radio of a UE due to periodic, sporadic, or occasional requirements to perform beam failure detection (BFD); short DRX cycles for a main radio of a UE due to periodic, sporadic, or occasional requirements to perform radio link monitoring (RLM); short DRX cycles for a main radio of a UE due to periodic, sporadic, or occasional requirements to determine paging reception; short DRX cycles for a main radio of a UE due to periodic, sporadic, or occasional requirements for SIB reception; short DRX cycles for a main radio of a UE due to periodic, sporadic, or occasional requirements to obtain synchronization; and/or the like.

Different technical problems such as those discussed above may be addressed by one or more different embodiments. Embodiments may address one or more of these problems associated with power consumption by a main radio of a UE. For instance, some embodiments that address problems associated with power consumption by a main radio of a UE may do so by one or more different technical means, such as, encoding, modulating, and transmitting SIBs with metrics for measurements by the LP-WUR; receiving, decoding and interpreting SIBs with metrics for measurements by the LP-WUR; performing measurements such as RRM measurement by the LP-WUR; performing cell selection and/or cell reselection by the LP-WUR and/or by the main radio; performing BFD by the LP-WUR; performing RLM by the LP-WUR; determining paging reception by the LP-WUR; obtaining synchronization by the LP-WUR; enabling longer DRX cycles by a main radio of the UE by waking the main radio as needed; and/or the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, cameras, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 4G LTE, 5G New Radio (NR) and/or 6G, technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally perform wireless communications according to other wireless communications technologies and/or standards. Examples of other wireless communications technologies and/or standards that may be used in various embodiments may include, without limitation, other IEEE wireless communication standards such as the IEEE 802.11-5220, IEEE 802.11ax-5221, IEEE 802.11ay-5221, IEEE 802.11ba-5221, and/or other specifications and standards, such as specifications developed by the Wi-Fi Alliance (WFA) Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS.331, 3GPP TS 38.133, 3GPP TS 38.306, 3GPP TS 38.321, 38.214, and/or 3GPP TS 38.331, and/or near-field communication (NFC) standards such as standards developed by the NFC Forum, including any revisions, progeny, and/or variants of any of the above. The embodiments are not limited to these examples.

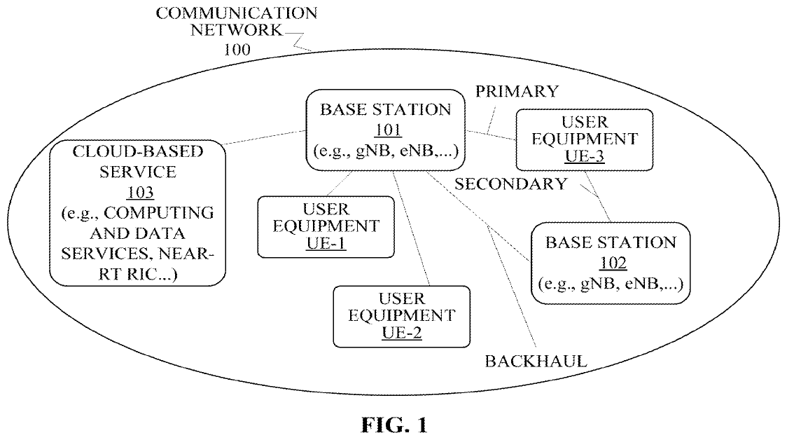

FIG. 1 illustrates a communication network 100 to reduce power consumption by main radios of UEs by performing low-power wake-up radio signaling to enable functionality by a LP-WUR and performing functionality via LP-WURs of the UEs. The communication network 100 is an Orthogonal Frequency Division Multiplex (OFDM) network comprising a primary base station 101, a secondary base station 102, a cloud-based service 103, a first user equipment UE-1, a second user equipment UE-2, and a third user equipment UE-3. One or more of the UEs may comprise LP-WURs to facilitate longer DRX cycles for corresponding main radios of the UEs to reduce overall power consumption rates by the one or more UEs.

In a 3GPP system based on an Orthogonal Frequency Division Multiple Access (OFDMA) downlink, the radio resource is partitioned into subframes in time domain and each subframe comprises of two slots. Each OFDMA symbol further consists of a count of OFDMA subcarriers in frequency domain depending on the system (or carrier) bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command. UEs may use cell-specific reference signals (CRS) for the demodulation of control/data channels in non-precoded or codebook-based precoded transmission modes, radio link monitoring and measurements of channel state information (CSI) feedback. UEs may use UE-specific reference signals (DM-RS) for the demodulation of control/data channels in non-codebook-based precoded transmission modes.

The communication network 100 may comprise a cell such as a micro-cell or a macro-cell and the base station 101 may provide wireless service to UEs within the cell. The base station 102 may provide wireless service to UEs within another cell located adjacent to or overlapping the cell. In other embodiments, the communication network 100 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, backhaul may comprise a wireless backhaul. In some embodiments, the backhaul may comprise an Xn interface or a F1 interface, which are interfaces defined between two RAN nodes or base stations such as the backhaul between the base station 101 and the base station 102. The Xn interface is an interface for gNBs and the F1 interface is an interface for gNB-Distributed units (DUs) if the architecture of the communication network 100 is a central unit/distributed unit (CU/DU) architecture. For instance, the base station 101 may comprise a CU and the base station 102 may comprise a DU in some embodiments. In other embodiments, both the base stations 101 and 102 may comprise eNBs or gNBs.

The base stations 101 and 102 may communicate protocol data units (PDUs) via the backhaul. As an example, for the Xn interface, the base station 101 may transmit or share control plane PDUs via an Xn-C interface and may transmit or share data PDUs via a Xn-U interface. For the F1 interface, the base station 101 may transmit or share control plane PDUs via an F1-C interface and may transmit or share data PDUs via a F1-U interface. Note that discussions herein about signaling, sharing, receiving, or transmitting via a Xn interface may refer to signaling, sharing, receiving, or transmitting via the Xn-C interface, the Xn-U interface, or a combination thereof. Similarly, discussions herein about signaling, sharing, receiving, or transmitting via a F1 interface may refer to signaling, sharing, receiving, or transmitting via the F1-C interface, the F1-U interface, or a combination thereof.

In some embodiments, the base stations 101 and 102 may comprise LP-WUR logic circuitry to determine, encode, modulate, and cause transmission of low-power wake-up radio signaling to LP-WURs of the UEs to advantageously enable longer DRX cycles for the corresponding main radios of the UEs.

In many embodiments, the LP-WUR logic circuitry of the base stations 101 and 102 may comprise memory or have access to memory to store and maintain configurations, descriptions, definitions, or indications of SIBs and/or information from SIBs such as metrics for measurements by the LP-WURs of the UEs to encode, modulate, and cause transmission of SIBs with metrics for measurements by the LP-WUR. In some embodiments, the memory may store configurations, descriptions, definitions, or indications for low-power wake-up radio signaling to enable measurements and/or other functionality (such as RLM, paging, BFD, synchronization, and/or the like) by the LP-WURs of the UEs. In some embodiments, the memory may store descriptions, definitions, configurations, or indications (such as a DRX cycle) for low-power wake-up radio signaling to determine when to send a LP-WUS to wake the main radios of the UEs.

In some embodiments, the LP-WUR logic circuitry of the UEs (UE-1, UE-2, and UE-3) may store and maintain configurations, descriptions, definitions, or indications of SIBs and/or information from SIBs such as metrics for measurements by the LP-WURs of the UEs to receive, decode, demodulate, and interpret SIBs with metrics for measurements by the LP-WUR. In some embodiments, the memory may store descriptions, definitions, or indications for low-power wake-up radio signaling to enable measurements and/or other functionality (such as RLM, paging, BFD, synchronization, and/or the like) by the LP-WURs of the UEs. In some embodiments, the memory may store configurations, descriptions, definitions, or indications for low-power wake-up radio signaling to determine when to monitor for a LP-WUS to wake the main radios of the UEs.

To illustrate, the LP-WUR logic circuitry of the base stations 101 and 102 may cause transmission of SIBs such as two or more of SIB1 through SIB5 to the LP-WURs of the UEs to communicate metrics for RRM measurements to the LP-WURs. The LP-WUR logic circuitry of the UEs may determine S criteria and R criteria from the SIBs to enable RRM measurements for cell reselection by the LP-WURs. Based on the S criteria and R criteria, receipt and measurement of WUS symbols of the LP-WUS via low-power wake-up radio signaling from the base station 101, the LP-WUR logic circuitry of UE-1 may determine the RRM measurement such as a reference signal received power (RSRP) measurement and/or a reference signal received quality (RSRQ) measurement. The LP-WUR logic circuitry may determine a configuration maintained in the memory of the UE for cell reselection. The configuration may define a transformation function for transforming RRM measurements based on metrics for the LP-WUR that includes a scaling factor and/or an offset to transform a RSRP and/or RSRQ measurement by the LP-WUR logic circuitry via the LP-WUR into an equivalent of a main radio RSRP and/or RSRQ measurement. After performing the transformation of the RSRP and/or RSRQ measurements, the LP-WUR logic circuitry of UE-1 may determine to select a neighbor cell as a better cell for communications with the communication network 100. In some embodiments, the LP-WUR logic circuitry may further register the UE-1 with the neighbor cell by waking the main radio by sending a wake-up signal from the LP-WUR to the main radio or otherwise causing the main radio to change from an off state or deep sleep state to an on state. The LP-WUR logic circuitry of UE-1 may communicate the selection of the neighbor cell to perform registration with the neighbor cell.

In other embodiments, after determining to change to a new cell such as the neighbor cell, the LP-WUR logic circuitry may wake the main radio to redo the RRM measurement, such as RSRP and/or RSRQ measurements, based on the measurement metrics for the LP-WUR. The LP-WUR logic circuitry of the UE-1 may select the best RRM measurement or determine a RRM measurement based on a function of the RRM measurement by the main radio and/or the RRM measurement by the LP-WUR to determine cell reselection. Based on measurements of the serving cell (the cell with which the UE-1 is currently registered such as base station 101) and the neighbor cell (e.g., base station 102), the LP-WUR logic circuitry of UE-1 may select the neighbor cell (base station 102) and register via the main radio with base station 102.

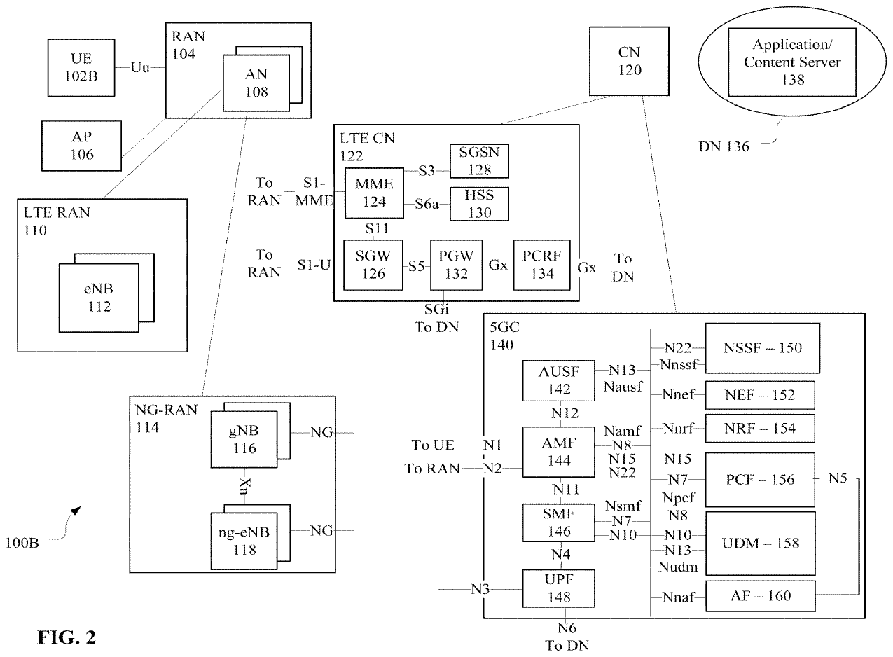

FIG. 2 illustrates an embodiment of a network 100B in accordance with various embodiments, such as the network 100 in FIG. 1. The network 100B may operate in a manner consistent with 3GPP technical specifications for LTE or 5G/NR systems as well as O-RAN specifications such as O-RAN “Near-Real-time RAN Intelligent Controller, E2 Service Model (E2SM), RAN Control”. However, the example embodiments are not limited in this regard and the described embodiments may apply to other networks that benefit from the principles described herein, such as future 3GPP systems, or the like.

The network 100B may include a UE 102B (such as the UE-1, UE-2, or UE-3 in FIG. 1), which may include any mobile or non-mobile computing device designed to communicate with a RAN 104 (such as the base station 101 or base station 102 in FIG. 1) via an over-the-air connection. The UE 102B may be communicatively coupled with the RAN 104 by a Uu interface. The UE 102B may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100B may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102B may additionally communicate with an AP 106 via an over-the-air connection. The AP 106 may manage a WLAN connection, which may serve to offload some/all network traffic from the RAN 104. The connection between the UE 102B and the AP 106 may be consistent with any IEEE 802.11 protocol, wherein the AP 106 could be a wireless fidelity (Wi-Fi®) router. In some embodiments, the UE 102B, RAN 104, and AP 106 may utilize cellular-WLAN aggregation (for example, LWA/LWIP). Cellular-WLAN aggregation may involve the UE 102B being configured by the RAN 104 to utilize both cellular radio resources and WLAN resources.

The RAN 104 may include one or more access nodes, for example, AN 108. AN 108 may terminate air-interface protocols for the UE 102B by providing access stratum protocols including RRC, PDCP, RLC, MAC, and L1 protocols. In this manner, the AN 108 may enable data/voice connectivity between CN 120 and the UE 102B. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102B with an air interface for network access. The UE 102B may be simultaneously connected with a plurality of cells provided by the same or different ANs of the RAN 104. For example, the UE 102B and RAN 104 may use carrier aggregation to allow the UE 102B to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 102B or AN 108 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high-speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNBs, for example, eNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 104 may be an NG-RAN 114 with gNBs, for example, gNB 116, or ng-eNBs, for example, ng-eNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102B can be configured with multiple BWPs where each BWP configuration has a different SCS. When a BWP change is indicated to the UE 102B, the SCS of the transmission is changed as well. Another use case example of BWP is related to power saving. In particular, multiple BWPs can be configured for the UE 102B with different amount of frequency resources (for example, PRBs) to support data transmission under different traffic loading scenarios. A BWP containing a smaller number of PRBs can be used for data transmission with small traffic load while allowing power saving at the UE 102B and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102B). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows. The MME 124 may implement mobility management functions to track a current location of the UE 102B to facilitate paging, bearer activation/deactivation, handovers, gateway selection, authentication, etc.

The SGW 126 may terminate an S1 interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102B and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an SGi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the SGi reference point between the PGW 132 and the data network 136 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, and AF 160 coupled with one another over interfaces (or “reference points”) as shown. Functions of the elements of the 5GC 140 may be briefly introduced as follows.

The AUSF 142 may store data for authentication of UE 102B and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102B and the RAN 104 and to subscribe to notifications about mobility events with respect to the UE 102B. The AMF 144 may be responsible for registration management (for example, for registering UE 102B), connection management, reachability management, mobility management, lawful interception of AMF-related events, and access authentication and authorization. The AMF 144 may provide transport for SM messages between the UE 102B and the SMF 146, and act as a transparent proxy for routing SM messages. AMF 144 may also provide transport for SMS messages between UE 102B and an SMSF. AMF 144 may interact with the AUSF 142 and the UE 102B to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling, and perform NAS ciphering and integrity protection. AMF 144 may also support NAS signaling with the UE 102B over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102B and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102B. The NSSF 150 may also determine allowed NSSAI and the mapping to the subscribed S-NSSAIs, if needed. The NSSF 150 may also determine the AMF set to be used to serve the UE 102B, or a list of candidate AMFs based on a suitable configuration and possibly by querying the NRF 154. The selection of a set of network slice instances for the UE 102B may be triggered by the AMF 144 with which the UE 102B is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 may handle subscription-related information to support the network entities' handling of communication sessions, and may store subscription data of UE 102B. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102B) for the NEF 152. The Nudr service-based interface may be exhibited by the UDR 546 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3rd party services to be geographically close to a point that the UE 102B is attached to the network. This may reduce latency and load on the network. To provide edge-computing implementations, the 5GC 140 may select a UPF 148 close to the UE 102B and execute traffic steering from the UPF 148 to data network 136 via the N6 interface. This may be based on the UE subscription data, UE location, and information provided by the AF 160. In this way, the AF 160 may influence UPF (re) selection and traffic routing. Based on operator deployment, when AF 160 is considered to be a trusted entity, the network operator may permit AF 160 to interact directly with relevant NFs. Additionally, the AF 160 may exhibit a Naf service-based interface.

The data network 136 may represent various network operator services, Internet access, or third-party services that may be provided by one or more servers including, for example, application/content server 138.

In some embodiments, the RAN 104 or one or more AN 108 may comprise LP-WUR logic circuitry to configure, define, determine, and generate low-power wake-up signaling for communication with a LP_WUR of the UE 102B. The LP-WUR logic circuitry of the RAN 104 may cause transmission of an OOK or FSK signal to the UE 102B to wake the main radio of the UE 102B, for measurements such as RRM measurements via the LP-WUR of the UE 102B, for paging via the LP-WUR of the UE 102B, for synchronization via the LP-WUR of the UE 102B, and/or the like.

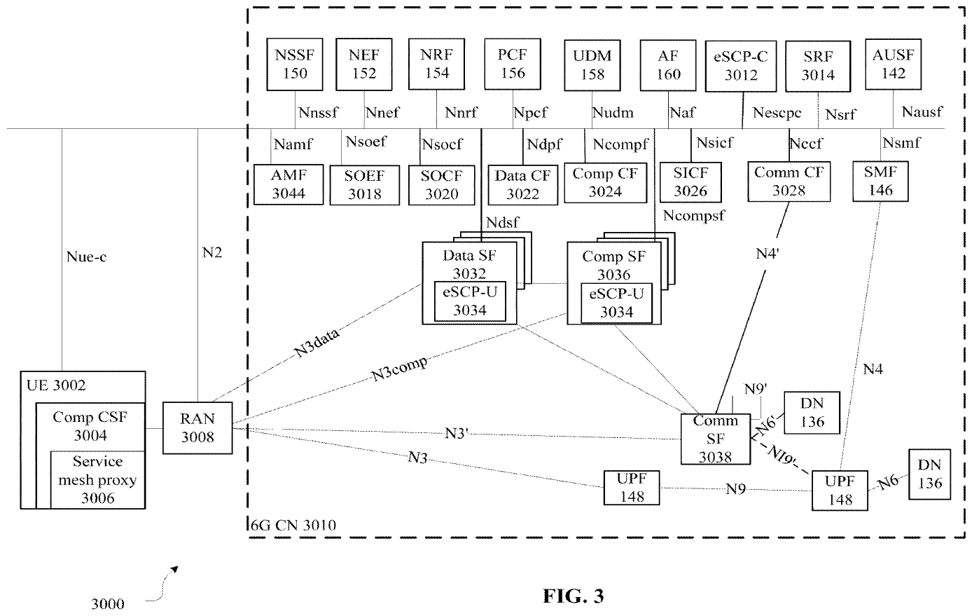

FIG. 3 illustrates an embodiment of a network 3000 such as the communication network 100 shown in FIG. 1, in accordance with various embodiments. The network 3000 may operate in a manner consistent with 3GPP technical specifications or technical reports for 6G systems. In some embodiments, the network 3000 may operate concurrently with network 100B. For example, in some embodiments, the network 3000 may share one or more frequency or bandwidth resources with network 100B. As one specific example, a UE (e.g., UE 3002) may be configured to operate in both network 3000 and network 100B. Such configuration may be based on a UE including circuitry configured for communication with frequency and bandwidth resources of both networks 100B and 3000. In general, several elements of network 3000 may share one or more characteristics with elements of network 100B. For the sake of brevity and clarity, such elements may not be repeated in the description of network 3000.

The network 3000 may include a UE 3002, which may include any mobile or non-mobile computing device designed to communicate with a RAN 3008 via an over-the-air connection. The UE 3002 may be similar to, for example, UE 102B. The UE 3002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 3, in some embodiments the network 3000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 3, the UE 3002 may be communicatively coupled with an AP such as AP 106 as described with respect to FIG. 2. Additionally, although not specifically shown in FIG. 3, in some embodiments the RAN 3008 may include one or more ANs such as AN 108 as described with respect to FIG. 2. The RAN 3008 and/or the AN of the RAN 3008 may be referred to as a base station (BS), a RAN node, or using some other term or name.

The UE 3002 and the RAN 3008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 3008 may allow for communication between the UE 3002 and a 6G core network (CN) 3010. Specifically, the RAN 3008 may facilitate the transmission and reception of data between the UE 3002 and the 6G CN 3010. The 6G CN 3010 may include various functions such as NSSF 150, NEF 152, NRF 154, PCF 156, UDM 158, AF 160, SMF 146, and AUSF 142. The 6G CN 3010 may additional include UPF 148 and DN 136 as shown in FIG. 3.

Additionally, the RAN 3008 may include various additional functions that are in addition to, or alternative to, functions of a legacy cellular network such as a 4G or 5G network. Two such functions may include a Compute Control Function (Comp CF) 3024 and a Compute Service Function (Comp SF) 3036. The Comp CF 3024 and the Comp SF 3036 may be parts or functions of the Computing Service Plane. Comp CF 3024 may be a control plane function that provides functionalities such as management of the Comp SF 3036, computing task context generation and management (e.g., create, read, modify, delete), interaction with the underlaying computing infrastructure for computing resource management, etc. Comp SF 3036 may be a user plane function that serves as the gateway to interface computing service users (such as UE 3002) and computing nodes behind a Comp SF instance. Some functionalities of the Comp SF 3036 may include: parse computing service data received from users to compute tasks executable by computing nodes; hold service mesh ingress gateway or service API gateway; service and charging policies enforcement; performance monitoring and telemetry collection, etc. In some embodiments, a Comp SF 3036 instance may serve as the user plane gateway for a cluster of computing nodes. A Comp CF 3024 instance may control one or more Comp SF 3036 instances.

Two other such functions may include a Communication Control Function (Comm CF) 3028 and a Communication Service Function (Comm SF) 3038, which may be parts of the Communication Service Plane. The Comm CF 3028 may be the control plane function for managing the Comm SF 3038, communication sessions creation/configuration/releasing, and managing communication session context. The Comm SF 3038 may be a user plane function for data transport. Comm CF 3028 and Comm SF 3038 may be considered as upgrades of SMF 146 and UPF 148, which were described with respect to a 5G system in FIG. 1B. The upgrades provided by the Comm CF 3028 and the Comm SF 3038 may enable service-aware transport. For legacy (e.g., 4G or 5G) data transport, SMF 146 and UPF 148 may still be used.

Two other such functions may include a Data Control Function (Data CF) 3022 and Data Service Function (Data SF) 3032 may be parts of the Data Service Plane. Data CF 3022 may be a control plane function and provides functionalities such as Data SF 3032 management, Data service creation/configuration/releasing, Data service context management, etc. Data SF 3032 may be a user plane function and serve as the gateway between data service users (such as UE 3002 and the various functions of the 6G CN 3010) and data service endpoints behind the gateway. Specific functionalities may include parse data service user data and forward to corresponding data service endpoints, generate charging data, and report data service status.

Another such function may be the Service Orchestration and Chaining Function (SOCF) 3020, which may discover, orchestrate and chain up communication/computing/data services provided by functions in the network. Upon receiving service requests from users, SOCF 3020 may interact with one or more of Comp CF 3024, Comm CF 3028, and Data CF 3022 to identify Comp SF 3036, Comm SF 3038, and Data SF 3032 instances, configure service resources, and generate the service chain, which could contain multiple Comp SF 3036, Comm SF 3038, and Data SF 3032 instances and their associated computing endpoints. Workload processing and data movement may then be conducted within the generated service chain. The SOCF 3020 may also be responsible for maintaining, updating, and releasing a created service chain.

Another such function may be the service registration function (SRF) 3014, which may act as a registry for system services provided in the user plane such as services provided by service endpoints behind Comp SF 3036 and Data SF 3032 gateways and services provided by the UE 3002. The SRF 3014 may be considered a counterpart of NRF 154, which may act as the registry for network functions.

Other such functions may include an evolved service communication proxy (eSCP) and service infrastructure control function (SICF) 3026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 3012 and eSCP-U 3034, for control plane service communication proxy and user plane service communication proxy, respectively. The SICF 3026 may control and configure eCSP instances in terms of service traffic routing policies, access rules, load balancing configurations, performance monitoring, etc.

Another such function is the AMF 3044. The AMF 3044 may be similar to 144, but with additional functionality. Specifically, the AMF 3044 may include potential functional repartition, such as move the message forwarding functionality from the AMF 3044 to the RAN 3008.

Another such function is the service orchestration exposure function (SOEF) 3018. The SOEF may be configured to expose service orchestration and chaining services to external users such as applications.

The UE 3002 may include an additional function that is referred to as a computing client service function (comp CSF) 3004. The comp CSF 3004 may have both the control plane functionalities and user plane functionalities, and may interact with corresponding network side functions such as SOCF 3020, Comp CF 3024, Comp SF 3036, Data CF 3022, and/or Data SF 3032 for service discovery, request/response, compute task workload exchange, etc. The Comp CSF 3004 may also work with network side functions to decide on whether a computing task should be run on the UE 3002, the RAN 3008, and/or an element of the 6G CN 3010.

The UE 3002 and/or the Comp CSF 3004 may include a service mesh proxy 3006. The service mesh proxy 3006 may act as a proxy for service-to-service communication in the user plane. Capabilities of the service mesh proxy 3006 may include one or more of addressing, security, load balancing, etc.

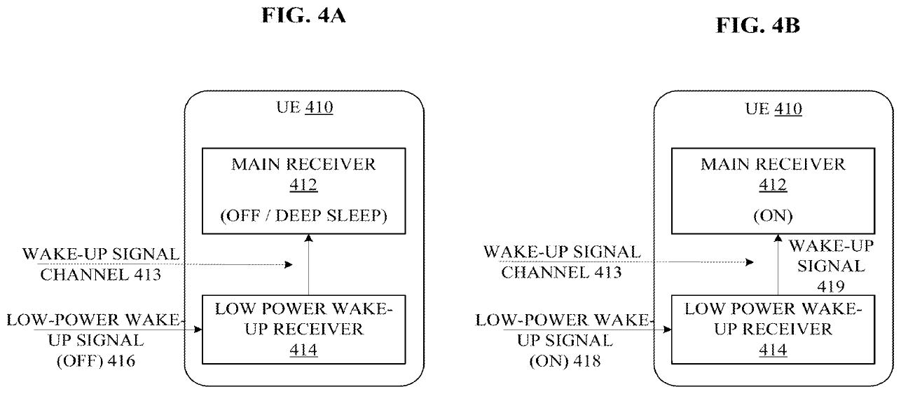

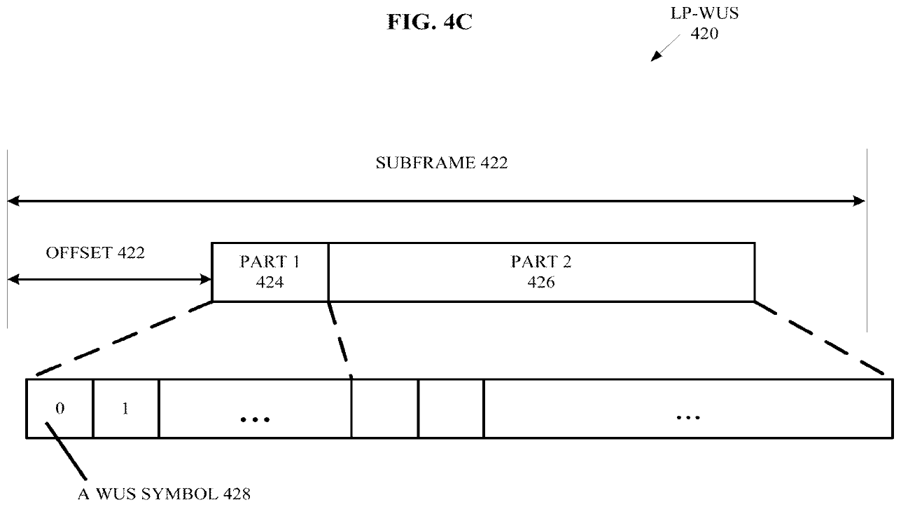

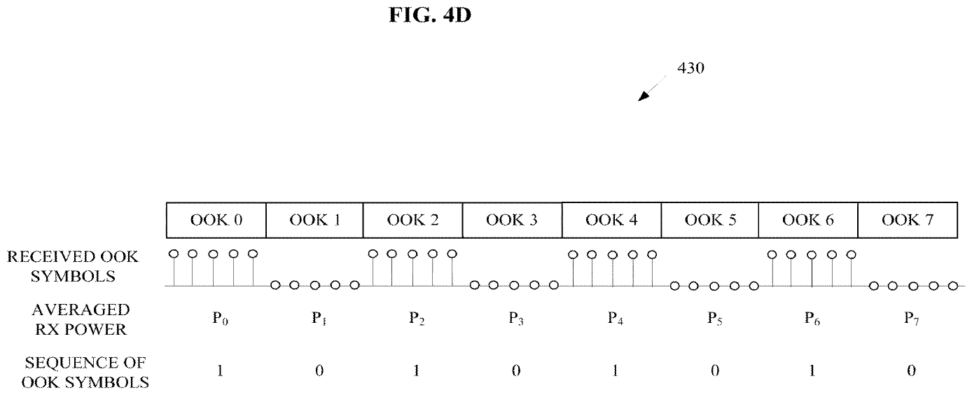

FIGS. 4A-4B illustrate embodiments of a UE that changes states to a power saving state and from the power saving mode to a powered state based on signaling via wake-up signals. FIG. 4A illustrates an embodiment of a UE 410 (such as the UE-1, UE-2, or UE-1 in FIG. 1) comprising a LP-WUR 414 transitioning a main receiver 412 from a powered state such as “on” to a power saving state such as “off” or a deep sleep. In the power saving state, if no low-power wake-up signal (LP-WUS) 418 is received by the LP-WUR 414 from a base station such as the base station 101 or 102 in FIG. 1, the main receiver 412 stays in the “off” state for deep sleep. On the other hand, as shown in FIG. 4B, if a LP-WUS 418 is received by the LP-WUR 414 from the base station, the LP-WUR 414 may trigger the main receiver 412 to turn on, or transition the main receiver 414 to the “on” state, via a wake-up signal 419 from the LP-WUR 414 to the main receiver 412. In the latter case, since the main receiver 412 is active, the wake-up receiver 414 may be turned off or transitioned to an off state. Note that the main receiver 412 may comprise a receiver portion of a main radio such as the main radio discussed in conjunction with FIG. 1 and waking up the main receiver 412 may, in some embodiments, involve waking up the main radio.

Note that, in other embodiments, the LP-WUR 414 may be integrated with or comprise a portion of the circuitry of the main receiver 412. In other words, one or more components of the circuitry of the LP-WUR 414 may also be components of the main receiver 412. In such embodiments, powering down the LP-WUR 414 may involve powering down circuitry that is dedicated to the LP-WUR 414 and not shared with the main receiver 412. Furthermore, in such embodiments, powering up the main radio 412 may involve powering additional components of the circuitry associated with functionality of the main receiver 412 such as a main transmitter. For example, in some embodiments, a baseband processor may comprise circuitry common to both the LP-WUR 414 and the main receiver 412 and may coordinate and/or execute functionality of the LP-WUR 414 and the main receiver 412. In other embodiments, the LP-WUR 414 and the main receiver 412 may comprise distinct or dedicated baseband processors, processor cores, or processing circuitry of one or more baseband processors.

The wake-up signal 419 may transmit via a wake-up signal channel 413 to trigger signal reception and/or transmission by the main receiver 412. Circuitry of the LP-WUR 414 and circuitry of the main receiver 412 may also communicate (transmit and/or receive) via the wake-up signal channel 413 for the purposes of measurement, such as radio resource management (RRM) measurement for a serving cell or neighbor cell, radio link monitoring (RLM) measurement, beam failure detection (BFD), synchronization, and/or the like. With the measurement by wake-up signal channel 413, the main receiver 412 may be turned off with larger periodicity to further reduce power consumption at UE 410 side.

Many embodiments may use a mechanism for measurement based on one or more LP-WUSs. For instance, some embodiments may define a metric for measurement by LP-WUS, a process for cell selection/reselection, a process for joint operation for RRM by LP-WUS and by the main radio, and processes for BFD, RLM, paging reception, and synchronization.

### Metric for Measurement by LP-WUS

A LP-WUS comprises multiple WUS symbols. In some embodiments, the LP-WUS may include at least a first part, a first part and a second part, or more than two parts. In some embodiments, more than one type of LP-WUS is established and configured to perform different functionality. In some embodiments, some types of LP-WUS may comprise only a first part, some types may comprise at least two parts, all types of LP-WUS may comprise only a first part, or types of LP-WUS may comprise at least two parts.

A metric of, e.g., RSRP or RSRQ measurement may be defined based on the reception of the WUS symbols of a LP-WUS by a LP-WUR. The LP-WUR logic circuitry of a UE may derive the measurement based on a first type of LP-WUS only, a second type of LP-WUS only, or both the first type of LP-WUS and the second type of LP-WUS. The LP-WUR logic circuitry of the UE may derive the measurement based on the first part of LP-WUS only, the second part of LP-WUS only, or both the first part of LP-WUS and the second part of LP-WUS.

### Cell Reselection

Cell selection/reselection refers to a process of detecting a better cell based on criteria and changing to the cell while in an idle mode such as an off state or deep sleep state. The process for cell selection/reselection involves performing one or more measurements of a signal from the neighbor cells, selecting the new cell based on the criteria, and performing registration to register the UE with the new cell. Cell reselection may occur after the UE performs cell selection and enters an idle mode. Cell reselection may involve measurements of a serving cell (cell with which the UE is currently registered) and one or more neighboring cells.

In general, cell selection may involve scanning energy levels from one or more neighbor cells and decoding a system information block (SIB), such as a SIB1 to determine a schedule for SIBs and a SIB2, that carries cell reselection parameters. Cell selection may involve estimating the cell selection criteria calculated via the one or more cell selection parameters and a predefined algorithm, choosing a new cell with the best criteria, and performing a registration process to register with the new cell. SIB1 defines scheduling of other system information including periodicity. SIB2 contains cell re-selection information common for intra-frequency, inter-frequency and/or inter-RAT cell re-selection. SIB3 contains information relevant to RSRQ cell reselection. SIB4 contains information relevant only for inter-frequency cell re-selection. And SIB5 contains information relevant only for inter-RAT cell re-selection.

In the procedure for cell reselection for an idle UE, the S criteria and R criteria are checked. In all cases, the UE shall reselect the new cell, only if the following conditions are met:
the new cell is better than the serving cell according to the cell reselection criteria specified above during a time interval Treselection_{RAT}; and
more than, e.g., 1 second has elapsed since the UE camped on the current serving cell.

The S criteria may be fulfilled when:

$$Srxlev > 0 AND Squal > 0$$

$$where :$$

$$Srxlev = Qrxlevmeas - ( Qrxlev min + Qrxlev min offset ) - Pcompensation - Qoffsettemp$$

$$Squal = Qqualmeas - ( Qqual min + Qqual min offset ) - Qoffsettemp$$

where:
   Srxlev is a cell selection receive (RX) level value (dB).
   Squal is a cell selection quality value (dB).
   Qrxlevmeas is a measured cell RX level value (RSRP).
   Qrxlevmin is a minimum required RX level in the cell (dBm). If the UE supports supplementary uplink (SUL) frequency for this cell, Qrxlevmin is obtained from RxLevMinSUL, if present, in SIB1, SIB2 and SIB4, additionally, if QrxlevminoffsetcellSUL is present in SIB3 and SIB4 for the concerned cell, this cell specific offset is added to the corresponding Qrxlevmin to achieve the required minimum RX level in the concerned cell; else Qrxlevmin is obtained from q-RxLevMin in SIB1, SIB2, and SIB4, additionally, if Qrxlevminoffsetcell is present in SIB3 and SIB4 for the concerned cell, this cell specific offset is added to the corresponding Qrxlevmin to achieve the required minimum RX level in the concerned cell.
   Qrxlevminoffset is an offset to the signaled Qrxlevmin taken into account in the Srxlev evaluation as a result of a periodic search for a higher priority PLMN while camped normally in a VPLMN, as specified in TS 23.122
   Pcompensation If the UE supports the additionalPmax in the NR-NS-PmaxList, if present, in SIB1, SIB2 and SIB4:

$$max ( PE MAX 1 - PPowerClass , 0 ) - ( min ( PE MAX 2 , PPowerClass ) - min ( PE MAX 1 , PPowerClass ) ) ( dB ) ;$$

$$else :$$

$$max ( PE MAX 1 - PPowerClass , 0 ) ( dB )$$

Qqualmeas is a measured cell quality value (RSRQ).
Qqualmin is a minimum required quality level in the cell (dB). Additionally, if Qqualminoffsetcell is signaled for the concerned cell, this cell specific offset is added to achieve the required minimum quality level in the concerned cell.
Qqualminoffset is an offset to the signaled Qqualmin taken into account in the Squal evaluation as a result of a periodic search for a higher priority PLMN while camped normally in a VPLMN, as specified in TS 23.122.
PEMAX1, PEMAX2 is a maximum transmission (TX) power level that a UE may use when transmitting on the uplink in the cell (dBm) defined as PEMAX in TS 38.101. If UE supports SUL frequency for this cell, PEMAX1 and PEMAX2 are obtained from the p-Max for SUL in SIB1 and NR-NS-PmaxList for SUL respectively in SIB1, SIB2 and SIB4 as specified in TS 38.331, else PEMAX1 and PEMAX2 are obtained from the p-Max and NR-NS-PmaxList respectively in SIB1, SIB2 and SIB4 for regular UL as specified in TS 38.331.

The R criteria may comprise Rs and Rn where:

$$Rs = Rs = Qmeas , s + Qhyst$$

$$Rn = Qmeas , n - Qoffset$$

where s is the serving cell and n is the neighboring cell. Qmeas is the measurement quantity used in cell reselection, Qoffset is the Qoffset,n between the serving cell and the neighbor cell for intra-frequency and is the Qoffset,n+Qoffsetfrequency for inter-frequency, Qoffsetfrequency is the frequency specific offset for equal priority frequencies, and Qhyst specifies the hysteresis value for ranking criteria. Treselection_{RAT} specifies the cell reselection timer value, which is applicable when evaluating reselection within a 5G NR system or toward another radio access technology (RAT).

In many embodiments, the LP-WUR logic circuitry of the UE may perform cell selection/reselection in two phases. A first phase may involve primary cell (PCell) selection/reselection and a second phase may involve secondary cell (SCell) selection/reselection. Selection/reselection criteria for an SCell may differ from the selection/reselection criteria for a PCell and may, in some embodiments, be configured by the selected Pcell or by higher layer signaling.

In the cell reselection procedure, the LP-WUR logic circuitry of the UE may receive the SIB1 and other necessary SIBs (e.g., one or more of SIB2 through SIB5) of the neighbor cell to determine the configuration of the neighbor cell. In short, the cell selection results in downlink (DL) reception with the main radio.

The LP-WUS based RRM measurement may be configured for both the serving cell and the neighbor cell(s). The neighbor cell may be in the same frequency or in a different frequency. Certain criteria for cell reselection, e.g., the S criteria and R criteria may be defined using the RRM measurements via a LP-WUS for the LP-WUR of the UE. The LP-WUR logic circuitry of the UE may use parameters in the calculation of S criteria and R criteria that may be separately configured for RRM measurements by the LP-WUR and by the main radio. In other embodiments, the LP-WUR logic circuitry of the UE may use parameters in the calculation of S criteria and R criteria that are configured and commonly applied to RRM measurements by the LP-WUR and by the main radio.

The LP-WUR logic circuitry of the UE may separately configure a set of neighbor cells for RRM measurements by the LP-WUR from the set of neighbor cells for RRM measurements by the main radio. In further embodiments, the LP-WUR logic circuitry of the UE may configure the set of neighbor cells for RRM measurements by the LP-WUR as the same as the set of neighbor cells for RRM measurements by the main radio.

In some embodiments, the LP-WUR logic circuitry of the UE may perform cell reselection and turn on the main radio when a neighbor cell is reselected according to S criteria and R criteria by the LP-WUR. In such embodiments, the LP-WUR logic circuitry of the UE may reselect the neighbor cell based only on the S criteria and R criteria by the LP-WUR. The LP-WUR logic circuitry of the UE may receive the SIB1 and other necessary SIBs of the neighbor cell (e.g., one or more of SIB2 through SIB5) to determine the configuration of the neighbor cell. The new configuration of the neighbor cells may include at least one of the system information, the paging configuration, and the LP-WUS configuration.

In some embodiments, the LP-WUR logic circuitry of the UE may perform cell reselection and reselect a neighbor cell according to S criteria and R criteria by the LP-WUR. In such embodiments, the LP-WUR logic circuitry of the UE may reselect the neighbor cell based only on the S criteria and R criteria by the LP-WUR. In such embodiments, if the UE receives an indication to receive system information in the neighbor cell, e.g., the system information update that is indicated by a LP-WUS from the serving cell and/or the neighbor cell, the LP-WUR logic circuitry of the UE may immediately, or shortly thereafter, receive the SIB1 and other necessary SIBs of the neighbor cell to determine the configuration of the neighbor cell; otherwise, the LP-WUR logic circuitry of the UE may not turn on the main radio for reception. In such embodiments, the LP-WUR logic circuitry of the UE may prepare to receive (determine a configuration for or configure) a LP-WUS for the neighbor cell to wake the main radio while the UE is camped to the neighbor cell beforehand but may only monitor for or act upon receipt of the LP-WUS (with the wake-up indication) from the neighbor cell after the neighbor cell is reselected. In other embodiments, the LP-WUR logic circuitry of the UE may configure a LP-WUS for the neighbor cell to wake the main radio after the neighbor cell is reselected.

In some embodiments, if a UE reselects a neighbor cell according to S criteria and R criteria by the LP-WUR, the LP-WUR logic circuitry of the UE may turn on the main radio and the main radio may redo RRM measurements for one or multiple neighbor cells with presumably better metrics of S criteria and R criteria for LP-WUR. Then, the LP-WUR logic circuitry of the UE may perform the cell reselection according to the S criteria and R criteria from the LP-WUR. The number of neighbor cells on which RRM measurements may be performed by main radio can be predefined, preconfigured or configured by higher layer signaling. In further embodiments, the minimum number of neighbor cells on which RRM measurements may be done by main radio can be predefined, preconfigured or configured by higher layer signaling.

In some embodiments, the S criteria and R criteria may be same as those defined in NR specification. In other embodiments, the S criteria and R criteria may differ from those defined in NR specification. For instance, the S criteria and R criteria may define, e.g., a threshold for RSRP and/or RSRQ measurements.

### Joint Operation for RRM by LP-WUS and by Main Radio

When the LP-WUS based RRM measurement is configured to relax the RRM by main radio, the LP-WUR logic circuitry of the UE may have both valid RRM measurements by the LP-WUR and valid RRM measurements by main radio. The LP-WUR logic circuitry of the UE may jointly consider the two types of RRM measurements when checking S criteria and R criteria for the potential cell reselection.

In some embodiments, if both valid RRM measurements by the LP-WUR and valid RRM measurements by the main radio are available for a cell at a moment, the LP-WUR logic circuitry of the UE may only check criteria for the potential cell reselection based on one type of RRM measurement for the cell. For example, the LP-WUR logic circuitry of the UE may prioritize the RRM measurements by the main radio for selecting the cell. In other words, the LP-WUR logic circuitry of the UE may assume that the RRM measurements by the main radio are better than the RRM measurements by the LP-WUR due to the additional resources available to the main radio or determine that the RRM measurements by the main radio are better based on predefined or preconfigured criteria.

In some embodiments, the LP-WUR logic circuitry of the UE may maintain a separate or distinct metric for validation for a RRM measurement by the LP-WUR and a separate or distinct metric for validation for a RRM measurement by the main radio. In some embodiments, the LP-WUR logic circuitry of the UE may select the RRM measurement with a larger validation metric to check the criteria for the potential cell reselection. The validation metric may be defined by the elapsed time after the RRM measurement is measured. For example, the validation metric can be set to a maximum value right after a RRM measurement is done by the LP-WUR or by the main radio. The validation metric is decremented as time elapses. The maximum value for the validation metric for the RRM by the LP-WUR and by the main radio may be separately configured by higher layer signaling and the LP-WUR logic circuitry of the UE may select the RRM measurement with the largest validation metric after both RRM measurements are completed.

In further embodiments, the same maximum value for the validation metric applies to both the RRM measurement by the LP-WUR and the RRM measurement by the main radio. The step for decreasing the validation metric for the RRM measurement by the LP-WUR and by the main radio may be separately configured by higher layer signaling. In other embodiments, the same step for decreasing the validation metric applies to the RRM measurement by the LP-WUR and by the main radio.

In some embodiments, the LP-WUR logic circuitry of the UE may transform a RRM measurement by the LP-WUR to an intermediate value. The LP-WUR logic circuitry of the UE may compare the RRM measurement by the LP-WUR with the RRM measurement by the main radio for the same or a different cell, or may combine the RRM measurement by the LP-WUR with the RRM measurement by the main radio for the same cell. Then, the LP-WUR logic circuitry of the UE may perform cell reselection according to S criteria and R criteria using the transformed values and the RRM measurements by main radio.

In some embodiments, the LP-WUR logic circuitry of the UE may consider a RRM measurement (M_{LR}) by the LP-WUR, equivalent to a RRM measurement by the main radio after transforming the RRM measurement (M_{LR}) by the LP-WUR by adding an offset: M_{MR}=M_{LR}+Δ. The Δ is an offset that may be predefined, preconfigured, or configured by higher layer signaling. The offset Δ may be common for both serving cell and neighbor cell measurement. In further embodiments, the offset Δ may be separately configured/determined for serving cell or neighbor cell measurement.

In some embodiments, the LP-WUR logic circuitry of the UE may consider a RRM measurement (M_{LR}) by the LP-WUR, equivalent to a RRM measurement by the main radio after multiplying the RRM measurement (M_{LR}) by the LP-WUR with a scaling factor and/or adding an offset: M_{MR}=c·M_{LR}+Δ. The c is scaling factor and the Δ is an offset. The c and Δ may be predefined, preconfigured or configured by higher layer signaling.

In some embodiments, other functions may be predefined, preconfigured or configured by higher layer signaling to transform a RRM measurement by the LP-WUR M_{LR} to be equivalent to a RRM measurement by main radio M_{MR}. In such embodiments, the LP-WUR logic circuitry of the UE may consider a RRM measurement (M_{LR}) by the LP-WUR, equivalent to a RRM measurement by the main radio after transforming the RRM measurement (M_{LR}) by the LP-WUR by a function, M_{MR}=ƒ(M_{LR}), where ƒ( ) is a function for the transform. For example, the validation level of a RRM measurement by the LP-WUR and/or by the main radio may be included in the function.

In some embodiments, the LP-WUR logic circuitry of the UE may derive a joint RRM measurement based on the RRM measurement by the LP-WUR and the RRM measurement by the main radio. Thereafter, the LP-WUR logic circuitry of the UE may perform cell reselection according to S criteria and R criteria using the joint RRM measurements.

In some embodiments, the LP-WUR logic circuitry of the UE may derive a joint RRM measurement M_{J} defined as M_{J}=aM_{MR}+bM_{LR}, where M_{LR}, M_{MR} are respectively the RRM measurement by the LP-WUR and the RRM measurement by the main radio, a, b are respectively the scaling factors to the RRM measurement by the LP-WUR and by the main radio. Note that a, b may be predefined, preconfigured or configured by higher layer signaling.

In some embodiments, the LP-WUR logic circuitry of the UE may derive a joint RRM measurement M_{J} defined as M_{J}=aM_{MR}+b (M_{LR}+Δ), where M_{LR}, M_{MR} are respectively the RRM measurement by the LP-WUR and the RRM measurement by the main radio, a, b are respectively the scaling factor for the RRM measurement by the LP-WUR and the RRM measurement by the main radio, and Δ is an offset. a, b, Δ may be predefined, preconfigured or configured by higher layer signaling.

In some embodiments, the LP-WUR logic circuitry of the UE may derive a joint RRM measurement via other functions to combine a RRM measurement by LP-WUS M_{LR} and a RRM measurement by main radio M_{MR}. In such embodiments, the LP-WUR logic circuitry of the UE may combine a RRM measurement (M_{LR}) by the LP-WUR and a RRM measurement by the main radio by a function, M_{J}=g(M_{LR}, M_{MR}), where g( ) is a function for the combination. For example, the validation level of a RRM measurement by the LP-WUR and/or by the main radio may be included in the function.

### Processes for BFD, RLM, Paging Reception, and Synchronization

In some embodiments, the LP-WUR logic circuitry of the UE may monitor low-power wake-up radio signaling, measure low-power wake-up radio signaling and determine or calculate metrics for the low-power wake-up radio signaling quality (e.g., RSRQ) over a predefined or preconfigured period of time to detect a predefined medium access control layer count of the number of times that low-power wake-up radio signaling fails to meet signal a quality threshold. If the count reaches or exceeds the count, the LP-WUR logic circuitry of the UE may determine a BFD event and, in some embodiments, the LP-WUR logic circuitry of the UE may wake the main radio with a wake-up signal or otherwise to indicate the BFD.

In some embodiments, the LP-WUR logic circuitry of the UE may monitor low-power wake-up radio signaling, measure low-power wake-up radio signaling and determine or calculate metrics for the low-power wake-up radio signaling quality (e.g., RSRQ) and performance (e.g., RSRP) to for RLM. In some embodiments, the LP-WUR logic circuitry of the UE may compare the quality and performance against one or more thresholds in accordance with a process predefined, preconfigured, or configured by, e.g., higher layer signaling and/or one or more SIBs. In some embodiments, the LP-WUR logic circuitry of the UE may wake the main radio with a wake-up signal or otherwise to indicate results of the RLM.

In some embodiments, the LP-WUR logic circuitry of the UE may monitor low-power wake-up radio signaling for paging. In some embodiments, the LP-WUR logic circuitry of the UE may receive paging information via the LP-WUS. In further embodiments, the LP-WUR logic circuitry of the UE may wake the main radio to receive paging information via the LP-WUS or via the main radio. In some embodiments, the LP-WUR logic circuitry of the UE may determine whether or not to wake the main radio based on one or more criteria such as a priority associated with the paging information.

In some embodiments, the LP-WUR logic circuitry of the UE may monitor low-power wake-up radio signaling for synchronization signals, measure low-power wake-up radio signaling, and determine or calculate timing and frequency offsets based on the synchronization signals. In some embodiments, the LP-WUR logic circuitry of the UE may wake the main radio in accordance with a process predefined, preconfigured, or configured by, e.g., higher layer signaling and/or one or more SIBs in response to synchronization signals and/or timing and frequency offsets based on the synchronization signals.

FIG. 4C is an embodiment of two parts of a low pow wake-up signal (LP-WUS) 420, which is allocated within a subframe 422. The LP-WUS 420 may use ON-OFF Keying (OOK) or frequency shift keying (FSK). In OFDM system, the OOK or FSK modulation may be mapped on multiple subcarriers, i.e., multi-carrier OOK (MC-OOK) or MC-FSK. A wake-up signal (WUS) symbol may represent an OOK symbol, a FSK symbol, a MC-OOK symbol or a MC-FSK symbol. In some embodiments, the LP-WUS 420 may further use the same waveform as other new radio (NR) channels/signals.

The LP-WUS 420 may consist of single part, two parts, or more than two parts. For a LP-WUS 420 comprising of single part (part 1 424), the LP-WUR logic circuitry of a base station may generate the LP-WUS 420 based on a sequence or coded payload information and cause transmission of the LP-WUS 420 to a LP-WUR of a UE. For a LP-WUS 420 consisting of two parts, the LP-WUR logic circuitry of a base station may generate the first part (part 1 424) based on a sequence, and the second part (part 2 426) comprising wake-up information using channel coding, and cause transmission of the LP-WUS 420 to a LP-WUR of a UE. The first part (part 1 424) may also carry one or more information bits such as the WUS symbol 428.

The LP-WUS 420 may serve at least one of the following purposes:
cell selection, e.g., a UE may identify the cell and perform RRM measurement based on the LP-WUS 420.
radio link monitoring (RLM).
beam management, e.g., beam failure detection (BFD).
determine paging reception.
determine system information block (SIB) reception.
obtain synchronization

To serve corresponding purposes, a single type or multiple different types of the LP-WUS 420 may be supported. For example, for all purposes, the LP-WUR logic circuitry of a base station may generate and cause transmission of a single LP-WUS 420 configuration. As another example, the LP-WUR logic circuitry of a base station may generate and cause transmission of multiple different types of LP-WUS 420 configured to serve different purposes. For example, the LP-WUR logic circuitry of a base station may generate and cause transmission of a first type of LP-WUS 420 periodically that can be used by the LP-WUR of a UE for synchronization and/or measurement.

Further, the LP-WUR logic circuitry of a base station may generate and cause transmission of a second type of LP-WUS 420 on demand to, e.g., wake up the main radio of the UE to receive paging, or periodically by configuring a resource of the second type of LP-WUS for periodicity. The second type of LP-WUS 420 may further support synchronization and/or measurement. At least for a UE in an RRC idle state, to receive the first and second type LP-WUS 420, the UE does not need to turn on the main radio of the UE. In such embodiments, the LP-WUR logic circuitry of the UE may turn on, or wake up, the main radio only if LP-WUR logic circuitry of the UE detects a certain type of LP-WUS 420 indicating to the UE to turn on the main radio. For example, the second type LP-WUS 420 may indicate paging reception for the UE in lieu of waking up the main radio to receive the paging, which advantageously reduces UE power consumption.

FIG. 4D illustrates an embodiment of a LP-WUS 430 for RSRP measurement by a LP-WUR of a UE. The LP-WUS 430 may comprise 8 OOK symbols (WUS symbols). Other embodiments may comprise more or less than 8 WUS symbols. The LP-WUS 430 may comprise multiple WUS symbols.

A metric of reference signal received power (RSRP) and/or a reference signal received quality (RSRQ) measurement may be defined by the LP-WUR logic circuitry of the UE based on the reception of the WUS symbols of a LP-WUS 430 by the LP-WUR of the UE. The LP-WUR logic circuitry of the UE may derive the measurement based on the first type of LP-WUS 430 only, based on the second type of LP-WUS 430 only, and/or based on both the first type of LP-WUS 430 and the second type of LP-WUS 430. The LP-WUR logic circuitry of the UE may derive the measurement based on the first part of LP-WUS only, the second part of LP-WUS only, or both the first part of LP-WUS and the second part of LP-WUS.

In some embodiments, part of a LP-WUS 430 comprises N WUS symbols such as FSK symbols, denote the sequence of information of the N FSK symbols as bₖ=0 or 1, k=0, 1, . . . , N−1, the RSRP based on the part may be defined in the following way:
An intermediate metric Pₖ₁-Pₖ₂ is firstly determined for a FSK symbol k, where Pₖ₁ is the average received power in the first frequency of the FSK symbol which represent value ‘1’, while Pₖ₂ is the average received power in the first frequency of the FSK symbol which represent value ‘0’;
The RSRP based on the N FSK symbols may be defined considering the sequence bₖ, i.e.,

$$RSCP = c / N \cdot {\sum }_{k = 0}^{N - 1} ( {P}_{k 1} - {P}_{k 2} ) \cdot ( 2 {b}_{k} - 1 )$$

The term (2bₖ−1) may enable unbiased measurement. c is a scaling factor.

Referring again to FIG. 4D, the averaged received powers of the 8 OOK symbols are respectively P₀ to P₇. The transmitted ON/OFF sequence is ‘1,0,1,0,1,0,1,0’. The RSRP measurement is

$${\sum }_{k = 0}^{7} {P}_{k} \cdot {( - 1 )}^{k} / 8.$$

In some embodiments, a part of a LP-WUS 430 comprises N OOK symbols. The RSRP may be defined as the average transmission power of all the ON symbols within the N OOK symbols.

In some embodiments, a part of a LP-WUS comprises N OOK symbols. Denote the sequence of ON or OFF information for the part as bₖ=0 or 1, k=0,1, . . . , N−1. The received signal strength indicator (RSSI) may be based on the part and may be defined in following way:
The average received power Pₖ for an OOK symbol k can be firstly determined using all samples of the WUS symbol k;
The RSSI based on the N OOK symbols may be defined by average the N average received power Pₖ, i.e.,

$$RSSI = c / N \cdot {\sum }_{k = 0}^{N - 1} {P}_{k}$$

c is a scaling factor.
For example, with the received OOK symbols as shown in FIG. 4D, the RSSI measurement is

$${\sum }_{k = 0}^{7} {P}_{k} / 8.$$

In some embodiments, a part of a LP-WUS 430 comprises N FSK symbols. Denote the sequence of information of the N FSK symbols as bₖ=0 or 1, k=0,1, . . . , N−1. The RSRP may be based on the part and may be defined in following way:
An intermediate metric Pₖ₁-Pₖ₂ is firstly determined for a FSK symbol k, where Pₖ₁ is the average received power in the first frequency of the FSK symbol, which represents value ‘1’, while Pₖ₂ is the average received power in the first frequency of the FSK symbol, which represents value ‘0’;
The RSRP based on the N FSK symbols may be the average of the N average received powers Pₖ, i.e.,

$$RSSI = c / N \cdot {\sum }_{k = 0}^{N - 1} ( {P}_{k 1} - {P}_{k 2} )$$

c is a scaling factor.

Based on the above definitions, a part of a LP-WUS 430 comprises N WUS symbols and the RSRQ may be defined by a RSRP divided by a corresponding RSSI.

In some embodiments, if multiple sequences of WUS symbols are transmitted on a part of a LP-WUS 430, the LP-WUR logic circuitry of the UE may detect the transmitted sequence firstly. After the sequence of the WUS symbols is detected, the LP-WUR logic circuitry of the UE may further derive the measurement based on the detected sequence. If a payload is encoded and transmitted on a part of a LP-WUS 430, the LP-WUR logic circuitry of the UE may decode the payload firstly. After the payload is decoded, the LP-WUR logic circuitry of the UE may regenerate the sequence of transmitted WUS symbols of the LP-WUS 430. Finally, the LP-WUR logic circuitry of the UE may further derive the measurement based on the regenerated sequence.

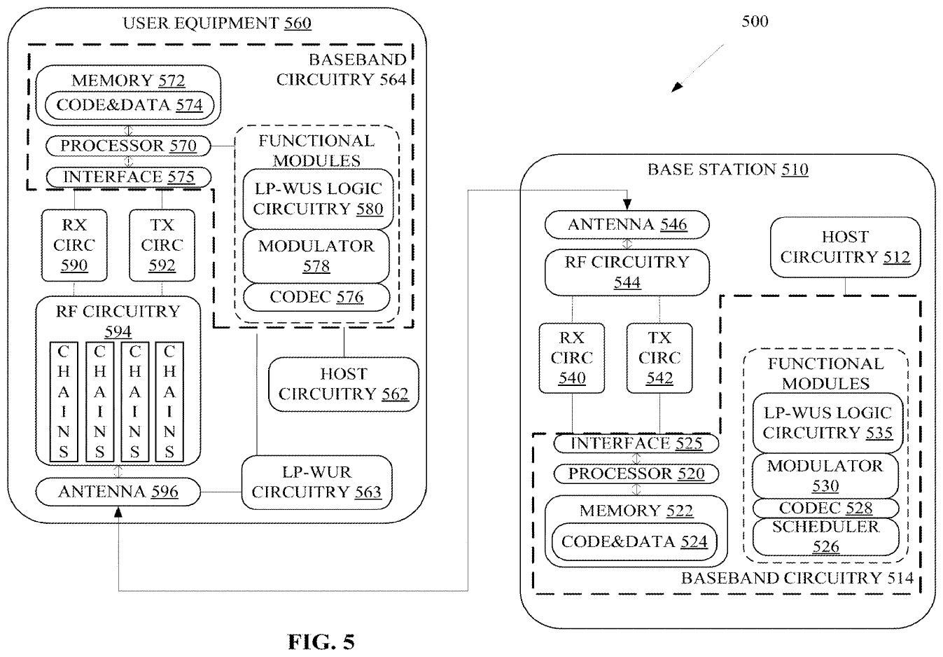

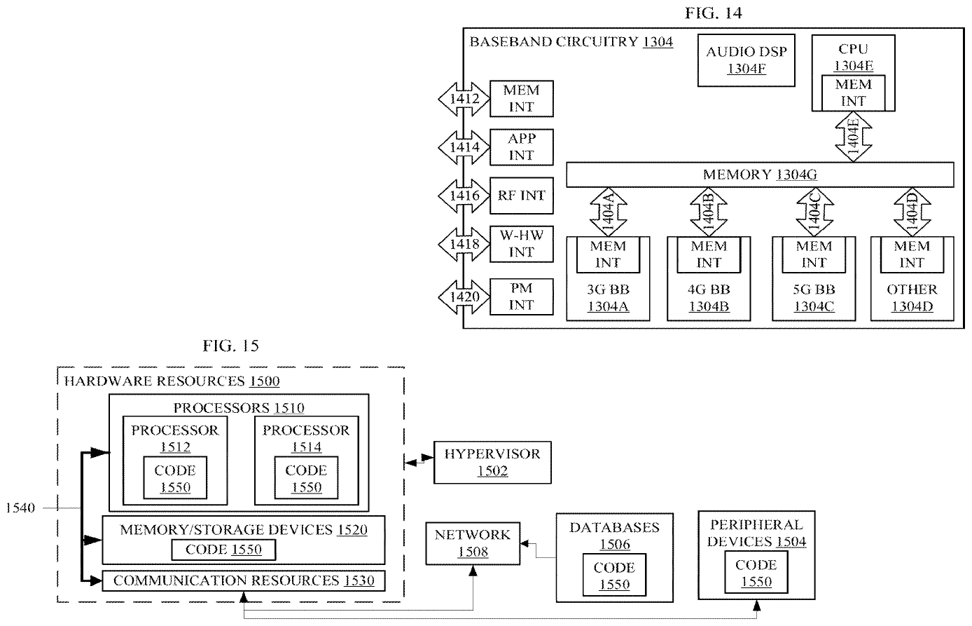

FIG. 5 is an embodiment of a simplified block diagram 500 of a base station 501 and a user equipment (UE) 511 that may carry out certain embodiments in a communication network such as the base stations or RANs, the UEs, and communication networks shown in FIGS. 1-4. For the base station 510, the antenna 546 transmits and receives radio signals. The RF circuitry 544 coupled with the antenna 546, which is the physical layer of the base station 510, receives RF signals from the antenna 546 and performs operations on the signals such as amplifying signals, and splitting the signals into quadrature phase and in-phase signals. The receiver circuitry 590 may convert the signals to digital baseband signals, or uplink data, and pass the digital in-phase and quadrature phase signals to the processor 520 of the baseband circuitry 514, also referred to as the processing circuitry or baseband processing circuitry, via an interface 525 (such as the RF interface 1416 shown in FIG. 14) of the baseband circuitry 514. In other embodiments, analog to digital converters of the processor 520 may convert the in-phase and quadrature phase signals to digital baseband signals.

The transmitter circuitry 592 may convert received, digital baseband signals, or downlink data, from the processor 520 to analog signals. The RF circuitry 544 processes and amplifies the analog signals and converts the analog signals to RF signals and passes the amplified, analog RF signals out to antenna 546.

The processor 520 decodes and processes the digital baseband signals, or uplink data, and invokes different functional modules to perform features in the base station 510. The memory 522 stores program instructions or code and data 524 to control the operations of the base station 510. The host circuitry 512 may execute code such as RRC layer code from the code and data 524 to implement RRC layer functionality and code.

A similar configuration exists in UE 560 where the antenna 596 transmits and receives RF signals. The RF circuitry 594, coupled with the antenna 596, receives RF signals from the antenna 596, amplifies the RF signals, and processes the signals to generate analog in-phase and quadrature phase signals. The receiver circuitry 590 processes and converts the analog in-phase and quadrature phase signals to digital baseband signals via an analog to digital converter, or downlink data, and passes the in-phase and quadrature phase signals to processor 570 of the baseband circuitry 564 via an interface 575 (such as the RF interface 1416 shown in FIG. 14) of the baseband circuitry 564. In other embodiments, the processor 570 may comprise analog to digital converters to convert the analog in-phase and quadrature phase signals to digital in-phase and quadrature phase signals.

The transmitter circuitry 592 may convert received, digital baseband signals, or downlink data, from the processor 570 to analog signals. The RF circuitry 594 processes and amplifies the analog signals and converts the analog signals to RF signals and passes the amplified, analog RF signals out to antenna 596.

The RF circuitry 594 illustrates multiple RF chains. While the RF circuitry 594 illustrates five RF chains, each UE may have a different number of RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 594 may include transmitter circuitry and receiver circuitry, which is often called transceiver circuitry. The transmitter circuitry may prepare digital data from the processor 570 for transmission through the antenna 596. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 570 decodes and processes the digital baseband signals, or downlink data, and invokes different functional modules to perform features in the UE 560. The memory 572 stores program instructions or code and data 574 to control the operations of the UE 560. The processor 570 may also execute medium access control (MAC) layer code of the code and data 574 for the UE 560. For instance, the MAC layer code may execute on the processor 570 to cause UL communications to transmit to the base station 510 via one or more of the RF chains of the physical layer (PHY). The PHY is the RF circuitry 594 and associated logic such as some or all the functional modules.

The host circuitry 562 may execute code such as RRC layer code to implement RRC layer functionality and code.

The base station 510 and the UE 560 may include several functional modules and circuits to carry out some embodiments. The different functional modules may include circuits or circuitry that code, hardware, or any combination thereof, can configure and implement. Each functional module that can implement functionality as code and processing circuitry or as circuitry configured to perform functionality, may also be referred to as a functional block. For example, the processor 520 (e.g., via executing program code 524) is a functional block to configure and implement the circuitry of the functional modules to allow the base station 510 to schedule (via scheduler 526), encode or decode (via codec 528), modulate or demodulate (via modulator 530), and transmit data to or receive data from the UE 560 via the RF circuitry 544 and the antenna 546.

The processor 570 (e.g., via executing program code in the code and data 574) may be a functional block to configure and implement the circuitry of the functional modules to allow the UE 560 to receive or transmit, de-modulate or modulate (via de-modulator 578), and decode or encode (via codec 576) data accordingly via the RF circuitry 594 and the antenna 596.

In many embodiments, the UE 560 may comprise LP-WUR circuitry 513. The LP-WUR circuitry 513 may comprise a low power receiver to receive, demodulate, and decode a LP-WUS such as the LP-WUSs described in conjunction with FIGS. 1-4.

In some embodiments, the LP-WUR circuitry 563 of the UE 560 may comprise distinct circuitry from the main radio (RF circuitry 594, receiver circuitry 590, and transmitter circuitry 592). In some embodiments, the LP-WUR circuitry 563 may use the same antenna 596 as the RF circuitry 594 but, in other embodiments, the LP-WUR circuitry 563 may have a separate antenna such as the antenna 596. In further embodiments, the LP-WUR circuitry 563 may share some components of the RF circuitry 594, receiver circuitry 590, and transmitter circuitry 592. In other embodiments, the LP-WUR circuitry 563 may be part of the RF circuitry 594, receiver circuitry 590, and transmitter circuitry 592 and not have separate components that are only used for the LP-WUR circuitry 563. In many embodiments, the LP-WUR circuitry 513 may be powered on while the main radio of the UE 560 is in an off state such as a deep sleep state during a DRX cycle.

The base station 510 may also include a functional module, LP-WUR logic circuitry 535. The LP-WUR logic circuitry 535 of the base station 510 may cause the processor 520 and/or the host circuitry 512 to perform actions to generate and cause transmission of LP-WUSs. For instance, the LP-WUS may comprise OFDM symbols where transmission of a symbol or part of a symbol may represent transmission of a WUS symbol with a logical bit value of 1 and the absence of transmission of a symbol or part of a symbol may represent transmission of a WUS symbol with a logical bit value of 0.

The LP-WUR logic circuitry 535 of the base station 510 may comprise configurations, definitions, and/or the like, or access the same stored in the memory 522, to define one or more types of LP-WUS. The LP-WUR logic circuitry 535 may maintain, in the memory 522, a status of the main radio and the LP-WUR circuitry 563 for the UE 560 while the UE 560 is registered with the base station 510 to determine when to send one or more types of a LP-WUS and when to transmit communications to the main radio to facilitate a reduction in the power consumption by the UE 560. For instance, the LP-WUR logic circuitry 535 of the base station 510 may encode, modulate, and transmit LP-WUSs with SIBs to communicate metrics for measurements by the LP-WUR circuitry 563 of the UE 560, to facilitate performance of measurements such as RRM measurements by the UE 560, to facilitate performance of cell selection/reselection by the UE 560, to facilitate performance of BFD by the UE 560, to facilitate performance of RLM by the UE 560, to facilitate performance of paging reception by the UE 560, to facilitate synchronization by the UE 560, or a combination thereof.

The UE 560 may also include a functional module, LP-WUR logic circuitry 580. The LP-WUR logic circuitry 580 of the UE 560 may cause the processor 520 and/or the host circuitry 512 to perform actions to advantageously offload functionality from the main radio (RF circuitry 594, receiver circuitry 590, and transmitter circuitry 592). The LP-WUR logic circuitry 580 of the UE 560 may receive, demodulate, decode, and interpret LP-WUSs via the LP-WUR circuitry 563 and one or more processors of the baseband circuitry 514. In other embodiments, the LP-WUR circuitry 563 may comprise or couple with a distinct processor or processor core for implementation of the LP-WUR logic circuitry 580. The LP-WUR logic circuitry 580 may interpret LP-WUSs to determine metrics for measurements such as RRM measurements, perform cell selection/reselection, perform BFD, perform RLM, perform paging reception, obtain synchronization information and, in some embodiments, perform synchronization.

FIG. 6 depicts a flowchart 6000 of an embodiment for cell reselection according to S criteria and R criteria first by LP-WUR of a UE via a LP-WUS and then by the main radio of the UE such as some embodiments described in conjunction with FIGS. 1-5. The flowchart 6000 begins with LP-WUR logic circuitry of the UE receiving, demodulating, decoding, and interpreting the LP-WUS via a LP-WUR to perform measurements such as RRM measurements to determine metrics such as a RSRP, a RSSI, RSRQ, or a combination thereof based on the LP-WUS (element 605). Thereafter, the LP-WUR logic circuitry may calculate or determine the S criteria and R criteria for a serving cell and one or more neighbor cells and compare the S criteria and R criteria of the different cells to determine whether to select a new cell or remain camped on the serving cell.

If a UE reselects a neighbor cell according to S criteria and R criteria by the LP-WUR (element 610), the LP-WUR logic circuitry of the UE may turn on the main radio and the LP-WUR logic circuitry may cause the main radio to redo RRM measurements (element 615) for the serving cell and the one or multiple neighbor cells with metrics for the S criteria and R criteria configured for the LP-WUR, which may be predefined, preconfigured, or configured by higher layer signaling. In some embodiments, the set of neighbor cells may have a predefined, preconfigured, or configured number of neighbor cells or a predefined, preconfigured, or configured minimum number of neighbor cells. In some embodiments, the main radio may perform the RRM measurements in accordance with a configuration for determining metrics for the S criteria and R criteria by the main radio, which may be predefined, preconfigured, or configured by higher layer signaling.

After determining the metrics for the S criteria and the R criteria for the serving cell and the one or more neighbor cells, the main radio logic circuitry of the UE may perform the cell reselection, which may involve ranking and comparing parameters related to the S criteria and R criteria, to select a new cell (one of the neighbor cells) or select the serving cell (element 620).

In some embodiments, if a UE reselects a neighbor cell according to S criteria and R criteria by the LP-WUR via the LP-WUS, the LP-WUR logic circuitry of the UE may turn on the main radio and the LP-WUR logic circuitry may redo RRM measurements with the main radio for the serving cell and all neighbor cells configured for RRM measurements by the main radio (which may be a different set of neighbor cells than the set of neighbor cells configured for the LP-WUR and/or be an overlapping set of neighbor cells with the set of neighbor cells configured for the LP-WUR). Then, the LP-WUR logic circuitry of the UE performs cell reselection according to S criteria and R criteria determined by main radio.

In some embodiments, the S criteria and R criteria may be same as those defined in current NR specification. In further embodiments, the S criteria and R criteria may be different from those defined in current NR specification. For example, the S criteria and R criteria may comprise one or more thresholds defined for RSRP and/or RSRQ measurements.

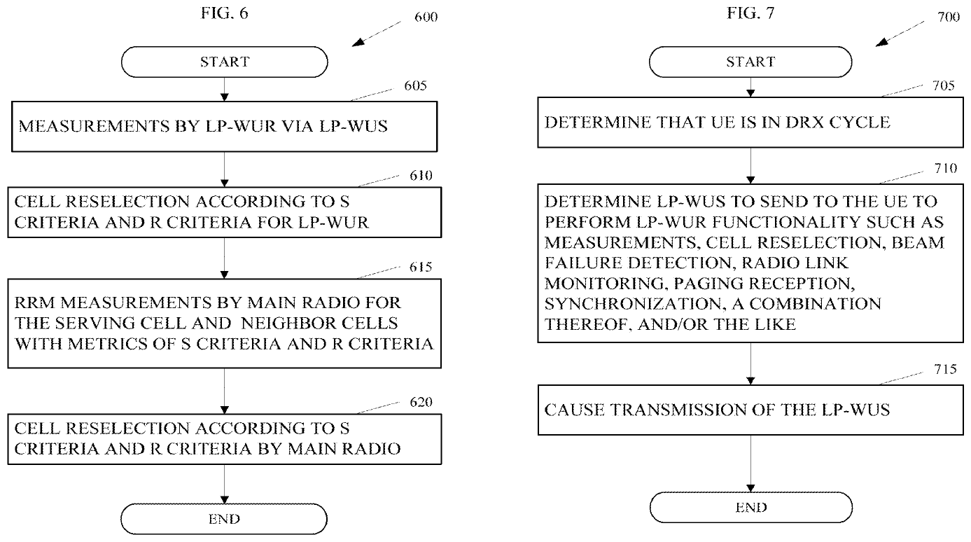

FIG. 7 depicts a flowchart 700 of an embodiment for a UE such as the embodiments described in conjunction with FIGS. 1-6. The flowchart 700 begins with LP-WUR logic circuitry of a base station of a cellular network determining that a UE is in a DRX cycle (element 705). For instance, the LP-WUR logic circuitry of the base station may determine that status of the UE as being in the DRX cycle based on a configuration for the DRX cycle that may reside in the memory of the base station. The configuration for the DRX cycle may, for instance, be negotiated between the UE and the base station and may or may not be based on a configuration, pre-configuration, definition, and/or the like provided by higher layer signaling.

After determining that the UE is in a DRX cycle, meaning that the main radio of the UE is in a deep sleep or off mode and the LP-WUR of the UE is powered on, the LP-WUR logic circuitry of the base station may determine and generate a LP-WUS to send to the UE to perform LP-WUR functionality (element 710) such as measurements, cell reselection, beam failure detection, radio link monitoring, paging reception, synchronization, a combination thereof, or the like. For instance, based on a service established for the UE with the base station, the LP-WUR logic circuitry of the base station may determine to, e.g., send a LP-WUS to the LP-WUR of the UE so the LP-WUR logic circuitry of the UE may perform RRM measurements via the LP-WUR of the UE. If there is a specific type of LP-WUS for that LP-WUR functionality (RRM measurement), the LP-WUR logic circuitry of the base station may select the LP-WUS for the LP-WUR functionality. If there is not a specific type of LP-WUS for the functionality or if there is only one type of LP-WUS, the LP-WUR logic circuitry of the base station may configure one or more parts of the LP-WUR (such as the first part and/or the second part) to perform the LP-WUS functionality, e.g., RRM measurement.

In some embodiments, generation of the LP-WUS may involve generation of WUS symbols for the LP-WUS by encoding and modulating the information for each of the parts of the LP-WUS (element 715) to form OOK symbols, MC-OOK symbols, FSK symbols, MC-FSK symbols, and/or the like, as described in conjunction with other FIGs. herein.

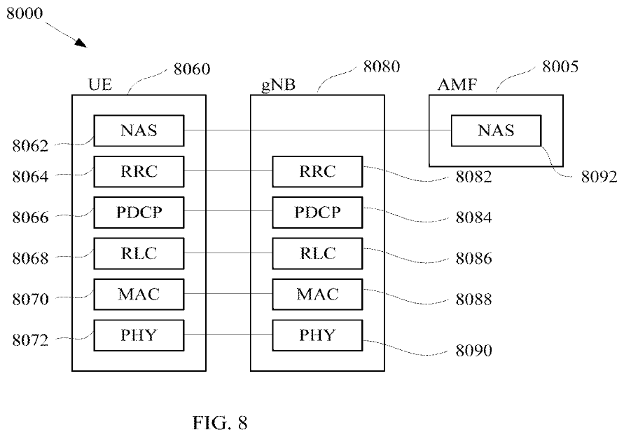

FIG. 8 depicts an embodiment of protocol entities 8000 that may be implemented in wireless communication devices discussed in conjunction with other FIGs. herein, including one or more of a user equipment (UE) 8060, a base station, which may be termed an evolved node B (eNB), or a new radio, next generation node B (gNB) 8080, and a network function, which may be termed a mobility management entity (MME), or an access and mobility management function (AMF) 8094, according to some aspects. In further embodiments, the NodeB may comprise an xNodeB for a 6^{th} generation or later NodeB.

According to some aspects, gNB 8080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 8060, gNB 8080 and AMF 8094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS). According to some aspects, one or more protocol entities that may be implemented in one or more of UE 8060, gNB 8080 and AMF 8094, may communicate with a respective peer protocol entity that may be implemented on another device, using the services of respective lower layer protocol entities to perform such communication.

According to some aspects, UE PHY layer 8072 and peer entity gNB PHY layer 8090 may communicate using signals transmitted and received via a wireless medium. According to some aspects, UE MAC layer 8070 and peer entity gNB MAC layer 8088 may communicate using the services provided respectively by UE PHY layer 872 and gNB PHY layer 8090. According to some aspects, UE RLC layer 8068 and peer entity gNB RLC layer 8086 may communicate using the services provided respectively by UE MAC layer 8070 and gNB MAC layer 8088. According to some aspects, UE PDCP layer 8066 and peer entity gNB PDCP layer 8084 may communicate using the services provided respectively by UE RLC layer 8068 and 5GNB RLC layer 8086. According to some aspects, UE RRC layer 8064 and gNB RRC layer 8082 may communicate using the services provided respectively by UE PDCP layer 8066 and gNB PDCP layer 8084. According to some aspects, UE NAS 8062 and AMF NAS 8092 may communicate using the services provided respectively by UE RRC layer 8064 and gNB RRC layer 8082.

The PHY layer 8072 and 8090 may transmit or receive information used by the MAC layer 8070 and 8088 over one or more air interfaces. The PHY layer 8072 and 8090 may further perform link adaptation or adaptive modulation and coding (AMC), power control, cell search (e.g., for initial synchronization and handover purposes), and other measurements used by higher layers, such as the RRC layer 8064 and 8082. The PHY layer 8072 and 8090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 8070 and 8088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 8068 and 8086 may operate in a plurality of modes of operation, including: Transparent Mode (TM), Unacknowledged Mode (UM), and Acknowledged Mode (AM). The RLC layer 8068 and 8086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 8068 and 8086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 8066 and 8084 may execute header compression and decompression of Internet Protocol (IP) data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 8064 and 8082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 8060 and the RAN node, gNB 8080 may utilize a Uu interface (e.g., an LTE-Uu interface) to exchange control plane data via a protocol stack comprising the PHY layer 8072 and 8090, the MAC layer 8070 and 8088, the RLC layer 8068 and 8086, the PDCP layer 8066 and 8084, and the RRC layer 8064 and 8082.

The non-access stratum (NAS) protocols 8092 form the highest stratum of the control plane between the UE 8060 and the AMF 8005. The NAS protocols 8092 support the mobility of the UE 8060 and the session management procedures to establish and maintain IP connectivity between the UE 8060 and the Packet Data Network (PDN) Gateway (P-GW).

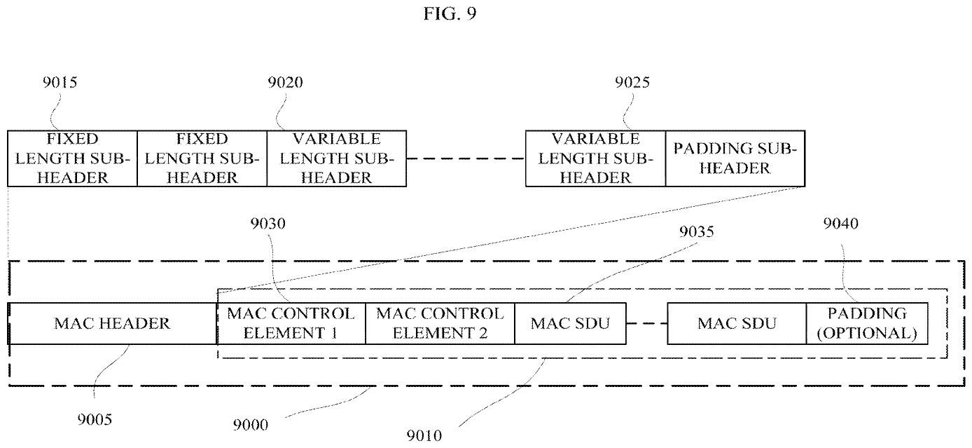

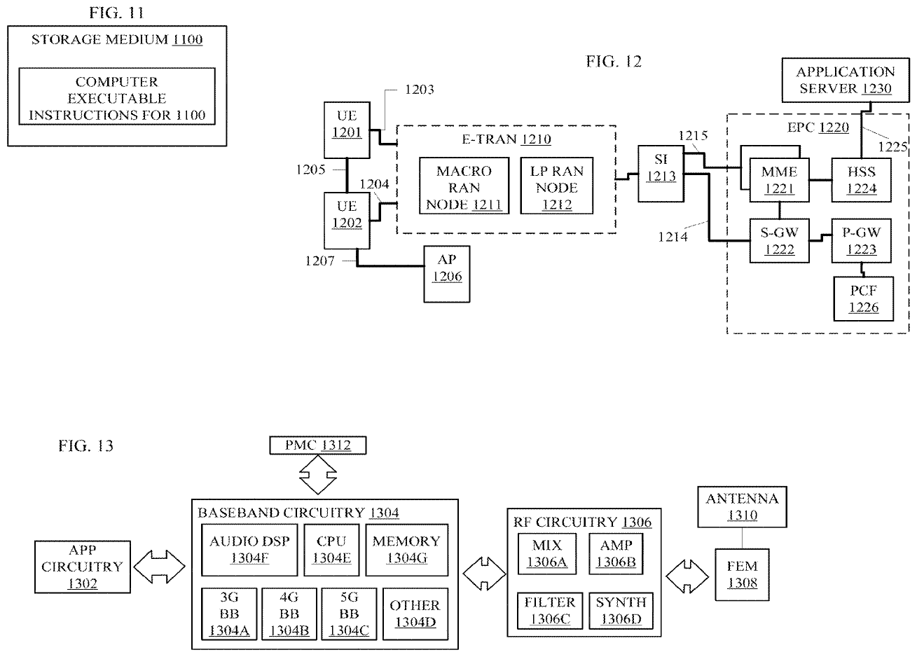

FIG. 9 illustrates embodiments of the formats of PHY data units (PDUs) that may be transmitted by the PHY device via one or more antennas and be encoded and decoded by a MAC entity such as the processors 520 and 570 discussed in conjunction with FIG. 5, the baseband circuitry 1304 discussed in conjunction with FIGS. 13 and 14, and/or discussed in conjunction with other FIGs. herein. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 9100 may consist of a MAC header 9105 and a MAC payload 9110, the MAC payload consisting of zero or more MAC control elements 9130, zero or more MAC service data unit (SDU) portions 9135 and zero or one padding portion 9140. According to some aspects, MAC header 8105 may consist of one or more MAC sub-headers, each of which may correspond to a MAC payload portion and appear in corresponding order. According to some aspects, each of the zero or more MAC control elements 9130 contained in MAC payload 9110 may correspond to a fixed length sub-header 9115 contained in MAC header 9105. According to some aspects, each of the zero or more MAC SDU portions 9135 contained in MAC payload 9110 may correspond to a variable length sub-header 9120 contained in MAC header 8105. According to some aspects, padding portion 9140 contained in MAC payload 9110 may correspond to a padding sub-header 9125 contained in MAC header 9105.

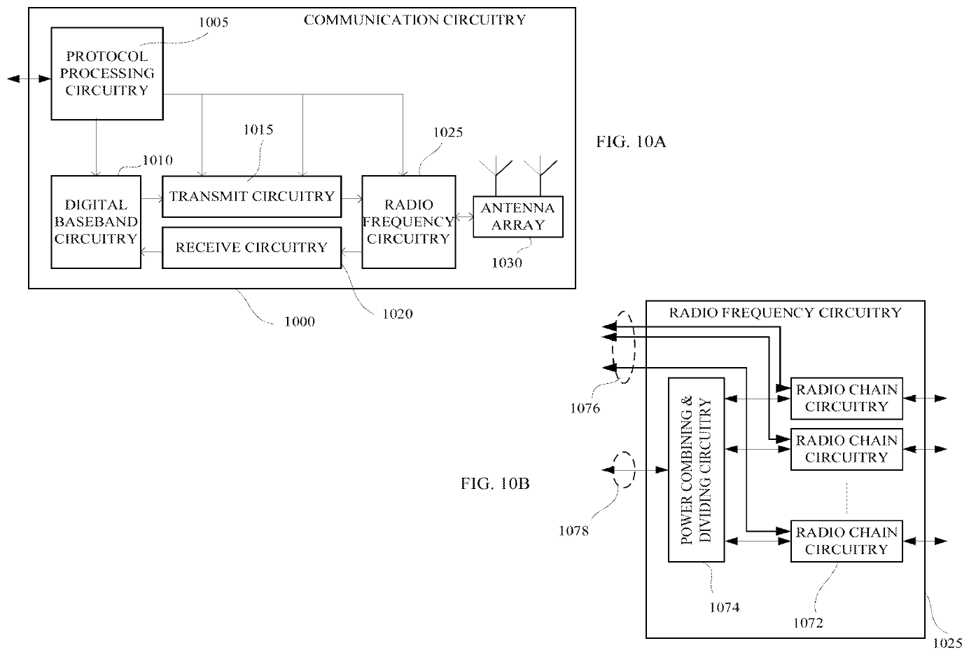

FIG. 10A illustrates an embodiment of communication circuitry 1000 such as the circuitry in the base station 510 and the user equipment 560 shown and discussed in conjunction with FIG. 5 or other FIGs. herein. The communication circuitry 1000 is alternatively grouped according to functions. Components as shown in the communication circuitry 1000 are shown here for illustrative purposes and may include other components not shown here in FIG. 10A.

The communication circuitry 1000 may include protocol processing circuitry 1005, which may implement one or more of medium access control (MAC), radio link control (RLC), packet data convergence protocol (PDCP), radio resource control (RRC) and non-access stratum (NAS) functions. The protocol processing circuitry 1005 may include one or more processing cores (not shown) to execute instructions and one or more memory structures (not shown) to store program (code) and data information.

The communication circuitry 1000 may further include digital baseband circuitry 1010, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 1000 may further include transmit circuitry 1015, receive circuitry 1020 and/or antenna array 1030 circuitry.

The communication circuitry 1000 may further include radio frequency (RF) circuitry 1025 such as the RF circuitry 544 and 594 in FIG. 2. In an aspect of an embodiment, RF circuitry 1025 may include multiple parallel RF chains for one or more of transmit or receive functions, each connected to one or more antennas of the antenna array 1030.

In an aspect of the disclosure, the protocol processing circuitry 1005 may include one or more instances of control circuitry (not shown) to provide control functions for one or more of digital baseband circuitry 1010, transmit circuitry 1015, receive circuitry 1020, and/or radio frequency circuitry 1025.

FIG. 10B illustrates an embodiment of radio frequency circuitry 1025 in FIG. 10A according to some aspects such as a RF circuitry 544 and 594 illustrated and discussed in conjunction with FIG. 5 or other FIGs. herein. The radio frequency circuitry 1025 may include one or more instances of radio chain circuitry 1072, which in some aspects may include one or more filters, power amplifiers, low noise amplifiers, programmable phase shifters and power supplies (not shown).

The radio frequency circuitry 1025 may include power combining and dividing circuitry 1074. In some aspects, power combining and dividing circuitry 1074 may operate bidirectionally, such that the same physical circuitry may be configured to operate as a power divider when the device is transmitting, and as a power combiner when the device is receiving. In some aspects, power combining and dividing circuitry 1074 may one or more include wholly or partially separate circuitries to perform power dividing when the device is transmitting and power combining when the device is receiving. In some aspects, power combining and dividing circuitry 1074 may include passive circuitry comprising one or more two-way power divider/combiners arranged in a tree. In some aspects, power combining and dividing circuitry 1074 may include active circuitry comprising amplifier circuits.

In some aspects, the radio frequency circuitry 1025 may connect to transmit circuitry 1015 and receive circuitry 1020 in FIG. 10A via one or more radio chain interfaces 1076 or a combined radio chain interface 1078. The combined radio chain interface 1078 may form a wide or very wide bandwidth.

In some aspects, one or more radio chain interfaces 1076 may provide one or more interfaces to one or more receive or transmit signals, each associated with a single antenna structure which may comprise one or more antennas.

In some aspects, the combined radio chain interface 1078 may provide a single interface to one or more receive or transmit signals, each associated with a group of antenna structures comprising one or more antennas.

FIG. 11 illustrates an example of a storage medium 1100 to store code and data for execution by any one or more of the processors and/or processing circuitry to perform the functionality of the logic circuitry described herein in conjunction with FIGS. 1-10 and 12-15. Storage medium 1100 may comprise an article of manufacture. In some examples, storage medium 1100 may include any non-transitory computer readable medium or machine-readable medium, such as an optical, magnetic or semiconductor storage. Storage medium 1100 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 12 illustrates an architecture of a system 1200 of a network in accordance with some embodiments. The system 1200 is shown to include a user equipment (UE) 1510 and a UE 1522 such as the UEs discussed in conjunction with FIGS. 1-11. The UEs 1510 and 1522 are illustrated as smartphones (e.g., handheld touch screen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1510 and 1522 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1510 and 1522 may to connect, e.g., communicatively couple, with a radio access network (RAN)—in this embodiment, an Evolved Universal Mobile Telecommunications System (UMTS) Terrestrial Radio Access Network (E-UTRAN) 1210 such as the base stations shown in FIGS. 1-11. The UEs 1510 and 1522 utilize connections 1520 and 1204, respectively, each of which comprises a physical communications interface or layer (discussed in further detail below); in this example, the connections 1520 and 1204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1510 and 1522 may further directly exchange communication data via a ProSe interface 1205. The ProSe interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1522 is shown to be configured to access an access point (AP) 1206 via connection 1207. The connection 1207 can comprise a local wireless connection, such as a connection consistent with any IEEE 802.11 protocol, wherein the AP 1206 would comprise a wireless fidelity (WiFi®) router. In this example, the AP 1206 is shown to be connected to the Internet without connecting to the core network of the wireless system (described in further detail below). The E-UTRAN 1210 can include one or more access nodes that enable the connections 1520 and 1204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1210 may include one or more RAN nodes for providing macro-cells, e.g., macro RAN node 1560, and one or more RAN nodes for providing femto-cells or picocells (e.g., cells having smaller coverage areas, smaller user capacity, or higher bandwidth compared to macro-cells), e.g., low power (LP) RAN node 1572.

Any of the RAN nodes 1560 and 1572 can terminate the air interface protocol and can be the first point of contact for the UEs 1510 and 1522. In some embodiments, any of the RAN nodes 1560 and 1572 can fulfill various logical functions for the E-UTRAN 1210 including, but not limited to, radio network controller (RNC) functions such as radio bearer management, uplink and downlink dynamic radio resource management and data packet scheduling, and mobility management.

In accordance with some embodiments, the UEs 1510 and 1522 can be configured to communicate using Orthogonal Frequency-Division Multiplexing (OFDM) communication signals with each other or with any of the RAN nodes 1560 and 1572 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1560 and 1572 to the UEs 1510 and 1522, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink (DL) channels that are conveyed using such resource blocks.

The physical downlink shared channel (PDSCH) may carry user data and higher-layer signaling to the UEs 1510 and 1522. The physical downlink control channel (PDCCH) may carry information about the transport format and resource allocations related to the PDSCH channel, among other things. It may also inform the UEs 1510 and 1522 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1560 and 1572 based on channel quality information fed back from any of the UEs 1510 and 1522. The downlink resource assignment information may be sent on the PDCCH used for (e.g., assigned to) each of the UEs 1510 and 1522.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1560 and 1572 may communicate with one another and/or with other access nodes in the E-UTRAN 1210 and/or in another RAN via an X2 interface, which is a signaling interface for communicating data packets between ANs. Some other suitable interface for communicating data packets directly between ANs may be used.

The E-UTRAN 1210 is shown to be communicatively coupled to a core network—in this embodiment, an Evolved Packet Core (EPC) network 1220 via an S1 interface 1570. In this embodiment the S1 interface 1570 is split into two parts: the SI-U interface 1214, which carries traffic data between the RAN nodes 1560 and 1572 and the serving gateway (S-GW) 1222, and the SI-mobility management entity (MME) interface 1215, which is a signaling interface between the RAN nodes 1560 and 1572 and MMEs 1546.

In this embodiment, the EPC network 1220 comprises the MMEs 1546, the S-GW 1222, the Packet Data Network (PDN) Gateway (P-GW) 1223, and a home subscriber server (HSS) 1224. The MMEs 1546 may be similar in function to the control plane of legacy Serving General Packet Radio Service (GPRS) Support Nodes (SGSN). The MMEs 1546 may manage mobility aspects in access such as gateway selection and tracking area list management. The HSS 1224 may comprise a database for network users, including subscription-related information to support the network entities' handling of communication sessions. The EPC network 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the S1 interface 1570 towards the E-UTRAN 1210, and routes data packets between the E-UTRAN 1210 and the EPC network 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1220 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP interface 1225. The application server 1230 can also be configured to support one or more communication services (e.g., Voice-over-Internet Protocol (VOIP) sessions, PTT sessions, group communication sessions, social networking services, etc.) for the UEs 1510 and 1522 via the EPC network 1220.

The P-GW 1223 may further be a node for policy enforcement and charging data collection. Policy and Charging Enforcement Function (PCRF) 1226 is the policy and charging control element of the EPC network 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QoS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

FIG. 13 illustrates example components of a device 1300 in accordance with some embodiments such as the base stations and UEs discussed in conjunction with FIGS. 1-12. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node such as a base station or gNB. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. The baseband circuitry 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304A, a fourth generation (4G) baseband processor 1304B, a fifth generation (5G) baseband processor 1304C, or other baseband processor(s) 1304D for other existing generations, generations in development or to be developed in the future (e.g., second generation (2G), sixth generation (6G), etc.). In many embodiments, the fourth generation (4G) baseband processor 1304B may include capabilities for generation and processing of the baseband signals for LTE radios and the fifth generation (5G) baseband processor 1304C may capabilities for generation and processing of the baseband signals for NRs.

The baseband circuitry 1304 (e.g., one or more of baseband processors 1304A-D) may handle various radio control functions that enable communication with one or more radio networks via the RF circuitry 1306. In other embodiments, some of or all the functionality of baseband processors 1304A-D may be included in modules stored in the memory 1304G and executed via a Central Processing Unit (CPU) 1304E. The radio control functions may include, but are not limited to, signal modulation/demodulation, encoding/decoding, radio frequency shifting, etc.

In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304F. The audio DSP(s) 1304F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1304 and the application circuitry 1302 may be implemented together such as, for example, on a system on a chip (SOC). In some embodiments, the baseband circuitry 1304 may provide for communication compatible with one or more radio technologies. For example, in some embodiments, the baseband circuitry 1304 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

The RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. The RF circuitry 1306 may include a receive signal path which may include circuitry to down-convert RF signals received from the FEM circuitry 1308 and provide baseband signals to the baseband circuitry 1304. The RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. The RF circuitry 1306 may also include synthesizer circuitry 1306d for synthesizing a frequency, or component carrier, for use by the mixer circuitry 1306a of the receive signal path and the transmit signal path. In some embodiments, the mixer circuitry 1306a of the receive signal path may to down-convert RF signals received from the FEM circuitry 1308 based on the synthesized frequency provided by synthesizer circuitry 1306d. The amplifier circuitry 1306b may amplify the down-converted signals and the filter circuitry 1306c may be a low-pass filter (LPF) or band-pass filter (BPF) to remove unwanted signals from the down-converted signals to generate output baseband signals. Output baseband signals may be provided to the baseband circuitry 1304 for further processing.

In some embodiments, the output baseband signals may be zero-frequency baseband signals, although this is not a requirement. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional NIN+I synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may synthesize an output frequency for use by the mixer circuitry 1306a of the RF circuitry 1306 based on a frequency input and a divider control input. In some embodiments, the synthesizer circuitry 1306d may be a fractional NIN+I synthesizer.

In some embodiments, frequency input may be an output of a voltage-controlled oscillator (VCO), although that is not a requirement. Divider control input may be an output of either the baseband circuitry 1304 or an application processor of the applications circuitry 1302 depending on the desired output frequency. Some embodiments may determine a divider control input (e.g., N) from a look-up table based on a channel indicated by the applications circuitry 1302.

The synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1306d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (ILO). In some embodiments, the RF circuitry 1306 may include an IQ/polar converter.

The FEM circuitry 1308 may include a receive signal path which may include circuitry to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM circuitry 1308, or in both the RF circuitry 1306 and the FEM circuitry 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In the present embodiment, the radio refers to a combination of the RF circuitry 130 and the FEM circuitry 1308. The radio refers to the portion of the circuitry that generates and transmits or receives and processes the radio signals. The RF circuitry 1306 includes a transmitter to generate the time domain radio signals with the data from the baseband signals and apply the radio signals to subcarriers of the carrier frequency that form the bandwidth of the channel. The PA in the FEM circuitry 1308 amplifies the tones for transmission and amplifies tones received from the one or more antennas 1310 via the LNA to increase the signal-to-noise ratio (SNR) for interpretation. In wireless communications, the FEM circuitry 1308 may also search for a detectable pattern that appears to be a wireless communication. Thereafter, a receiver in the RF circuitry 1306 converts the time domain radio signals to baseband signals via one or more functional modules such as the functional modules shown in the base station 510 and the user equipment 560 illustrated in FIG. 2.

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 1312 may be additionally or alternatively coupled with, and perform similar power management operations for, other components such as, but not limited to, application circuitry 1302, RF circuitry 1306, or FEM circuitry 1308.

In some embodiments, the PMC 1312 may control, or otherwise be part of, various power saving mechanisms of the device 1300. For example, if the device 1300 is in an RRC Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1302 and the processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 14 illustrates example interfaces of baseband circuitry in accordance with some embodiments such as the baseband circuitry shown and/or discussed in conjunction with FIGS. 1-13. As discussed above, the baseband circuitry 1304 of FIG. 13 may comprise processors 1304A-1304E and a memory 1304G utilized by said processors. Each of the processors 1304A-1304E may include a memory interface, 1404A-1404E, respectively, to send/receive data to/from the memory 1304G.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein in conjunction with FIGS. 1-14. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

In embodiments, one or more elements of FIGS. 12, 13, 14, and/or 15 may be configured to perform one or more processes, techniques, or methods as described herein, or portions thereof. In embodiments, one or more elements of FIGS. 12, 13, 14, and/or 15 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of “a processor”. Note that “a processor” may comprise one or more processors and each processor may comprise one or more processor cores that independently or interdependently process code and/or data. Each of the processor cores are also “processors” and are only distinguishable from processors for the purpose of describing a physical arrangement or architecture of a processor with multiple processor cores on one or more dies and/or within one or more chip packages. Processor cores may comprise general processing cores or may comprise processor cores configured to perform specific tasks, depending on the design of the processor. Processor cores may be processors with one or more processor cores. As discussed and claimed herein, when discussing functionality performed by a processor, processing circuitry, or the like; the processor, processing circuitry, or the like may comprise one or more processors, each processor having one or more processor cores, and any one or more of the processors and/or processor cores may reside on one or more dies, within one or more chip packages, and may perform part of or all the processing required to perform the functionality.

One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

### Some Advantage Effects of Embodiments

While not an exhaustive list, several embodiments have one or more potentially advantages effects. The enhancements advantageously enable encoding, modulating, and transmitting SIBs with metrics for measurements by the LP-WUR; receiving, decoding and interpreting SIBs with metrics for measurements by the LP-WUR; performing measurements such as RRM measurement by the LP-WUR; performing cell selection and/or cell reselection by the LP-WUR and/or by the main radio; performing beam failure detection (BFD) by the LP-WUR; performing radio link monitoring (RLM) by the LP-WUR; determining paging reception by the LP-WUR; obtaining synchronization by the LP-WUR; enabling longer DRX cycles by a main radio of the UE by waking the main radio as needed; and/or the like to advantageously reduce power consumption by a main radio of the UE.

### EXAMPLES OF FURTHER EMBODIMENTS

The following examples pertain to further embodiments. Specifics in the examples may be used anywhere in one or more embodiments.

Example 1 is an apparatus for a user equipment (UE) to support low-power wake-up radio signaling, comprising: an interface; and processing circuitry coupled with the interface to perform operations to: decode a low-power wake-up signal (LP-WUS) received via the interface, the LP-WUS comprising wake-up signal (WUS) symbols, the WUS symbols modulated with an on-off keying (OOK) modulation or a frequency shift keying (FSK) modulation, the LP-WUS comprising information to perform at least one low-power wake-up radio (LP-WUR) function via a LP-WUR of the UE while a main radio of the UE is powered off, wherein the LP-WUR function comprises measurement of at least part of the LP-WUS; and determine at least one metric based on the measurement. In Example 2, the apparatus of Example 1, wherein the processing circuitry comprises a processor and a memory coupled with the processor, the apparatus further comprising the LP-WUR and the main radio coupled with the processing circuitry, one or more antennas coupled with radio frequency circuitry of the LP-WUR and the main radio. In Example 3, the apparatus of Example 1, wherein the at least one metric comprises a reference signal received power (RSRP), a reference signal received quality (RSRQ), a received signal strength indicator (RSSI), or a combination thereof. In Example 4, the apparatus of Example 3, wherein determination of the at least one metric comprises determination of the average received power Pₖ for an OOK symbol k, and determination of the RSRP according to the following equation wherein bₖ is a bit a sequence of N OOK symbols, bₖ=0 or 1, k=0 through N−1, and c is a scaling factor:

$$RSRP = c / N \cdot {\sum }_{k = 0}^{N - 1} {P}_{k} \cdot ( 2 {b}_{k} - 1 ) .$$

In Example 5, the apparatus of Example 4, wherein determination of the at least one metric comprises determination of the average received power Pₖ for an OOK symbol k and determination of the RSSI by averaging Pₖ of the N OOK symbols according to the following equation wherein k=0 through N−1, and c is a scaling factor,

$$RSSI = c / N \cdot {\sum }_{k = 0}^{N - 1} {P}_{k} .$$

In Example 6, the apparatus of Example 1, wherein S criteria and R criteria for cell reselection are defined using the radio resource management (RRM) measurements on the LP-WUS. In Example 7, the apparatus of any one of Examples 1-6, the processor to perform further operations to perform cell reselection and wake up the main radio to perform a joint RRM measurement derived based on the RRM measurement by LP-WUR and an RRM measurement by the main radio. Example 8, the apparatus of any one of Examples 1-6, the processor to perform further operations to perform cell reselection and wake the main radio if a neighbor cell is selected.

Example 9 is a machine-readable medium containing instructions, which when executed by a processor, cause the processor of a base station to perform operations, the operations to decode a low-power wake-up signal (LP-WUS) received via an interface, the LP-WUS comprising wake-up signal (WUS) symbols, the WUS symbols modulated with an on-off keying (OOK) modulation or a frequency shift keying (FSK) modulation, the LP-WUS comprising information to perform at least one low-power wake-up radio (LP-WUR) function via a LP-WUR of the UE while a main radio of the UE is powered off, wherein the LP-WUR function comprises measurement of at least part of the LP-WUS; and determine at least one metric based on the measurement. In Example 10, the machine-readable medium of Example 9, wherein the at least one metric comprises a reference signal received power (RSRP), a reference signal received quality (RSRQ), a received signal strength indicator (RSSI), or a combination thereof. In Example 11, the machine-readable medium of Example 10, wherein determination of the at least one metric comprises determination of the average received power Pₖ for an OOK symbol k, and determination of the RSRP according to the following equation wherein bₖ is a bit a sequence of N OOK symbols, bₖ=0 or 1, k=0 through N−1, and c is a scaling factor:

$$RSRP = c / N \cdot {\sum }_{k = 0}^{N - 1} {P}_{k} \cdot ( 2 {b}_{k} - 1 ) .$$

In Example 12, the machine-readable medium of Example 11, wherein determination of the at least one metric comprises determination of the average received power Pₖ for an OOK symbol k and determination of the RSSI by averaging Pₖ of the N OOK symbols according to the following equation wherein k=0 through N−1, and c is a scaling factor,

$$RSSI = c / N \cdot {\sum }_{k = 0}^{N - 1} {P}_{k} .$$

In Example 13, the machine-readable medium of Example 9, the processor to perform further operations to perform cell reselection and if a neighbor cell is selected according to S criteria and R criteria for the LP-WUR, wake the main radio and redo radio resource management (RRM) measurements on the LP-WUS for one or multiple neighbor cells with metrics of the S criteria and R criteria for the LP-WUR. In Example 14, the machine-readable medium of any Example 9-12, the processor to perform further operations to perform cell reselection and if a neighbor cell is selected according to S criteria and R criteria for the LP-WUR, wake the main radio and redo radio resource management (RRM) measurements for a serving cell and for one or multiple neighbor cells with metrics of the S criteria and R criteria for the main radio.

Example 15 is an apparatus of a base station to support low-power wake-up radio signaling, comprising: an interface; and processing circuitry coupled with the interface to perform operations to: generate a low-power wake-up signal (LP-WUS) for a user equipment (UE), the LP-WUS comprising wake-up signal (WUS) symbols, the WUS symbols modulated with an on-off keying (OOK) modulation or a frequency shift keying (FSK) modulation, the LP-WUS comprising information to perform at least one low-power wake-up radio (LP-WUR) function via a LP-WUR of the UE while a main radio of the UE is powered off, wherein the LP-WUR function comprises measurement of at least part of the LP-WUS; and cause transmission of the LP-WUS via the interface. In Example 16, the apparatus of Example 15, wherein the processing circuitry comprises a processor and a memory coupled with the processor, the apparatus further comprising the LP-WUR and the main radio coupled with the processing circuitry, one or more antennas coupled with radio frequency circuitry of the LP-WUR and the main radio. In Example 17, the apparatus of Example 16, the processor circuitry to further perform operations to generate a second LP-WUS configured for the LP-WUR to perform paging reception. In Example 18, the apparatus of Example 15, wherein the LP-WUS comprises a first type of LP-WUS of more than one type of LP-WUS. In Example 19, the apparatus of Example 15, wherein the LP-WUS comprise a first part and a second part, wherein the first part comprises a sequence and the second part comprises the information. In Example 20, the apparatus of any of Examples 16-19, wherein the LP-WUS is configured for the LP-WUR to perform cell reselection, beam failure detection (BFD), radio link monitoring (RLM), synchronization, or a combination thereof.

Example 21 is a method comprising any action described in any one of Examples 1-20.

Example 22 is an apparatus comprising a means for any method in Example 21.

Example 23 is a machine-readable medium containing instructions, which when executed by a processor, cause the processor to perform operations, the operations including any method in Example 21.

1-20. (canceled)

21. An apparatus for a user equipment (UE) to support low-power wake-up radio signaling, comprising:
an interface; and
processing circuitry coupled with the interface to perform operations to:
decode a low-power wake-up signal (LP-WUS) received via the interface, the LP-WUS comprising wake-up signal (WUS) symbols, the WUS symbols modulated with an on-off keying (OOK) modulation or a frequency shift keying (FSK) modulation, the LP-WUS comprising information to perform at least one low-power wake-up radio (LP-WUR) function via a LP-WUR of the UE while a main radio of the UE is powered off, wherein the LP-WUR function comprises measurement of at least part of the LP-WUS; and
determine at least one metric based on the measurement.

22. The apparatus of claim 21, wherein the processing circuitry comprises a processor and a memory coupled with the processor, the apparatus further comprising the LP-WUR and the main radio coupled with the processing circuitry, one or more antennas coupled with radio frequency circuitry of the LP-WUR and the main radio.

23. The apparatus of claim 21, wherein the at least one metric comprises a reference signal received power (RSRP), a reference signal received quality (RSRQ), a received signal strength indicator (RSSI), or a combination thereof.

24. The apparatus of claim 23, wherein determination of the at least one metric comprises determination of the average received power Pₖ for an OOK symbol k, and determination of the RSRP according to the following equation wherein bₖ is a bit a sequence of N OOK symbols, bₖ=0 or 1, k=0 through N−1, and c is a scaling factor:
$$RSRP = c / N \cdot {\sum }_{k = 0}^{N - 1} {P}_{k} \cdot ( 2 {b}_{k} - 1 ) .$$

25. The apparatus of claim 24, wherein determination of the at least one metric comprises determination of the average received power Pₖ for an OOK symbol k and determination of the RSSI by averaging Pₖ of the N OOK symbols according to the following equation wherein k=0 through N−1, and c is a scaling factor,
$$RSSI = c / N \cdot {\sum }_{k = 0}^{N - 1} {P}_{k} .$$

26. The apparatus of claim 21, wherein S criteria and R criteria for cell reselection are defined using the radio resource management (RRM) measurements on the LP-WUS.

27. The apparatus of claim 21, the processor to perform further operations to perform cell reselection and wake up the main radio to perform a joint RRM measurement derived based on the RRM measurement by LP-WUR and an RRM measurement by the main radio.

28. The apparatus of claim 21, the processor to perform further operations to perform cell reselection and wake up the main radio if a neighbor cell is selected.

29. A machine-readable medium containing instructions, which when executed by a processor, cause the processor of a base station to perform operations, the operations to:
decode a low-power wake-up signal (LP-WUS) received via an interface, the LP-WUS comprising wake-up signal (WUS) symbols, the WUS symbols modulated with an on-off keying (OOK) modulation or a frequency shift keying (FSK) modulation, the LP-WUS comprising information to perform at least one low-power wake-up radio (LP-WUR) function via a LP-WUR of the UE while a main radio of the UE is powered off, wherein the LP-WUR function comprises measurement of at least part of the LP-WUS; and
determine at least one metric based on the measurement.

30. The machine-readable medium of claim 29, wherein the at least one metric comprises a reference signal received power (RSRP), a reference signal received quality (RSRQ), a received signal strength indicator (RSSI), or a combination thereof.

31. The machine-readable medium of claim 30, wherein determination of the at least one metric comprises determination of the average received power Pₖ for an OOK symbol k, and determination of the RSRP according to the following equation wherein bₖ is a bit a sequence of N OOK symbols, bₖ=0 or 1, k=0 through N−1, and c is a scaling factor:
$$RSRP = c / N \cdot {\sum }_{k = 0}^{N - 1} {P}_{k} \cdot ( 2 {b}_{k} - 1 ) .$$

32. The machine-readable medium of claim 31, wherein determination of the at least one metric comprises determination of the average received power Pₖ for an OOK symbol k and determination of the RSSI by averaging Pₖ of the N OOK symbols according to the following equation wherein k=0 through N−1, and c is a scaling factor,
$$RSSI = c / N \cdot {\sum }_{k = 0}^{N - 1} {P}_{k} .$$

33. The machine-readable medium of claim 29, the processor to perform further operations to perform cell reselection and if a neighbor cell is selected according to S criteria and R criteria for the LP-WUR, wake up the main radio and redo radio resource management (RRM) measurements on the LP-WUS for one or multiple neighbor cells with metrics of the S criteria and R criteria for the LP-WUR.

34. The machine-readable medium of claim 29, the processor to perform further operations to perform cell reselection and if a neighbor cell is selected according to S criteria and R criteria for the LP-WUR, wake up the main radio and redo radio resource management (RRM) measurements for a serving cell and for one or multiple neighbor cells with metrics of the S criteria and R criteria for the main radio.

35. An apparatus of a base station to support low-power wake-up radio signaling, comprising:
an interface; and
processing circuitry coupled with the interface to perform operations to:
generate a low-power wake-up signal (LP-WUS) for a user equipment (UE), the LP-WUS comprising wake-up signal (WUS) symbols, the WUS symbols modulated with an on-off keying (OOK) modulation or a frequency shift keying (FSK) modulation, the LP-WUS comprising information to perform at least one low-power wake-up radio (LP-WUR) function via a LP-WUR of the UE while a main radio of the UE is powered off, wherein the LP-WUR function comprises measurement of at least part of the LP-WUS; and
cause transmission of the LP-WUS via the interface.

36. The apparatus of claim 35, wherein the processing circuitry comprises a processor and a memory coupled with the processor, the apparatus further comprising radio frequency circuitry coupled with the processing circuitry, one or more antennas coupled with radio frequency circuitry.

37. The apparatus of claim 35, the processor circuitry to further perform operations to generate a second LP-WUS configured for the LP-WUR to perform paging reception.

38. The apparatus of claim 35, wherein the LP-WUS comprises a first type of LP-WUS of more than one type of LP-WUS.

39. The apparatus of claim 35, wherein the LP-WUS comprises a first part and a second part, wherein the first part comprises a sequence and the second part comprises the information.

40. The apparatus of claim 36, wherein the LP-WUS is configured for the LP-WUR to perform cell reselection, beam failure detection (BFD), radio link monitoring (RLM), synchronization, or a combination thereof.
